(19) United States
(12) Patent Application Publication
(10) Pub. No.: US 2002/0077986 A1
(43) Pub. Date: Jun. 20, 2002

(54) Controlling and managing digital assets

(76) Inventors: Hiroshi Kobata, Newton, MA (US); Robert Gagne, Brookline, MA (US)

Correspondence Address: JOHN F. HAYDEN, Fish & Richardson P.C., 601 Thirteenth Street, NW, Washington, DC, 20005, US

(21) Appl. No.: 09/904,564

(22) Filed: Jul. 16, 2001

Related U.S. Application Data
(60) Provisional application No. 60/240,077, filed on Oct. 16, 2000.
(60) Provisional application No. 60/224,894, filed on Aug. 14, 2000.
(60) Provisional application No. 60/218,242, filed on Jul. 14, 2000.
(60) Provisional application No. 60/289,795, filed on May 10, 2001.

(51) Int. Cl. G06F 17/60; H04L 9/00; H04K 1/00

(52) U.S. Cl. 705/52; 705/51

(57) ABSTRACT

Systems and techniques are provided for controlling and managing digital assets. These systems and techniques are particularly useful when digital assets are transmitted electronically using, for example, the Internet, as these techniques serve to make the Internet secure for communication and control of digital assets. In addition, they permit dynamic control and management of digital assets, regardless of where the assets reside. Use of these systems and techniques promises to enable new, Internet-based distribution models, and to provide superior insight with respect to the use and status of digital assets. Particular implementations of the systems and techniques permit features such as lifetime control of digital content, multi-level control of digital content (including session encryption, asset encryption, and remote management), and try-before-you buy marketing approaches. They also support functions such as digital rights transfer, tracking, segmentation, archiving, and improved handling of upgrades and updates.

### CROSS-REFERENCE TO RELATED APPLICATIONS

This application claims priority from U.S. Provisional Application Nos. 60/240,077, filed Oct. 16, 2000, and titled “Software Dynamic Rights Management”; No. 60/224,894, filed Aug. 14, 2000, and titled “Secure Document Collaboration”; No. 60/218,242, filed Jul. 14, 2000, and titled “Dynamic Digital Rights Management”; and No. 60/289,795, filed May 10, 2001, and titled “Controlling and Managing Digital Assets” all of which are incorporated by reference.

### TECHNICAL FIELD

This invention generally relates to dynamically controlling and managing digital assets.

### BACKGROUND

The Internet is an international collection of interconnected networks currently providing connectivity among millions of computer systems. One popular form of network communication among Internet users is electronic mail (e-mail). E-mail is a “store and forward” service that enables sending computer systems to electronically exchange text messages and computer files with receiving computer systems across the globe. A text message passes over the Internet from computer system to computer system until the message arrives at its destination. Computer files often accompany the text messages as attachments.

Another popular avenue for exchanging information among computer systems is the World Wide Web (“Web”). The Web is a part of the Internet that provides a graphics and audio-oriented technology used by computer systems to access a wide variety of digital information, such as files, documents, images, and sounds, stored on other computer systems, called “Web sites.” A Web site includes electronic pages or documents called “Web pages.” Often, a Web page has links, called hyperlinks, to files and documents at other Web pages on the Web.

Computer system users can access and obtain digital information from these Web sites using a graphical user interface (GUI) produced by executing client software called a “browser.” Examples of commercially available Web browsers include Netscape Navigator™ and Microsoft Internet Explorer™. Web browsers use a variety of standardized methods (i.e., protocols) for addressing and communicating with Web sites. A common protocol for publishing and viewing linked text documents is the HyperText Transfer Protocol (HTTP).

To access a Web page at a Web site, a computer system user enters the address of the Web page, called a Uniform Resource Locator (URL), in an address box provided by the Web browser. The URL can specify the location of a Web server or a Web page on a Web server. Accessing a Web page downloads the contents of that Web page to the requesting computer system. The result of such downloading can include a wide variety of outputs at the computer system, including any combination of text, graphics, audio, and video information (e.g., images, motion pictures, and animation). Accessing the Web page also can invoke execution of an application program.

For the information provider, a consequence of making information accessible using the above-described techniques, which include sending e-mail and downloading Web pages, may be a loss of control over the accessed information. That is, after e-mailing the information to the receiving system or making a Web page publicly available on the Internet, control of the information passes to the receiver. Thereafter, any attempt by the sender to keep the information from further dissemination is dependent upon the receiver. Most often, any such attempt is thwarted, particularly on the Internet where the receivers of the information can be numerous and anonymous.

Controlling digital assets is becoming a paramount need for many companies and individuals, including, for example, digital content creators, businesses and artists. Although the Internet has presented a convenient channel for communication and distribution, the Internet does not, in general, provide an efficient method of protecting digital products and sensitive business information communicated over the Internet.

The ease with which digital content is distributed has both positive and negative ramifications. An advantage is that digital content developers can easily package and deliver the digital content to end-users in electronic format using a network such as the Internet or by electronic transfer media such as CD-ROMs or floppy disks. One disadvantage is that others who receive the distributed digital content have the ability to copy and/or modify and/or distribute the digital content without authorization from the digital content provider.

Control of digital content includes control of electronic delivery and control of digital rights in the content after delivery. Control of electronic delivery may include encrypting, protecting, authenticating and securing the connection between source and destination points, so that the digital content is not tampered with during delivery and can be transferred securely and privately. However, once the digital content arrives at a destination point, that protection and control of the digital content may be lost. As such, the digital content creator may not be able to maintain and enforce rights in the digital content.

### SUMMARY

Systems and techniques are provided for controlling and managing digital assets. These systems and techniques are particularly useful when digital assets are transmitted electronically using, for example, the Internet, as these techniques serve to make the Internet secure for communication and control of digital assets. In addition, they permit dynamic control and management of digital assets, regardless of where the assets reside. Use of these systems and techniques promises to enable new, Internet-based distribution models, and to provide superior insight with respect to the use and status of digital assets. Particular implementations of the systems and techniques permit features such as lifetime control of digital content, multi-level control of digital content (including session encryption, asset encryption, and remote management), and try-before-you buy marketing approaches. They also support functions such as digital rights transfer, tracking, segmentation, archiving, and improved handling of upgrades and updates.

Implementations may obtain these results using transmitted rights and secure communications connections. In particular, the sender of a digital asset and the recipient of the digital asset communicate through secure connections to an intermediate server. Each secure connection (i.e., the connection between the sender and the server and the connection between the recipient and the server) is established using a handshaking procedure that employs public-key encryption to generate a session key that then is used to encrypt communications between the sender or the recipient and the server.

Transmission of the digital assets using the secure communications connections ensures that the digital assets (which typically are encrypted) may be placed in a controlled environment in which access to the assets can be limited. For example, the environment may permit the digital asset to be manipulated only by a particular viewer and only in particular ways that are consistent with the rights granted to the recipient. The rights granted to the recipient for viewing, printing, or otherwise manipulating a digital asset may be defined in a document that is transmitted to the recipient using the secure communications channel and is loaded into a secure database at the recipient. The viewer interacts with the database to control access to the digital asset.

The rights provided to the user may be changed by subsequent delivery of a revised rights document (or of a rights document that just includes changes in the rights). For example, a demonstration version of a piece of software may be sent to a user with very limited associated access rights. If the user subsequently makes arrangements to purchase the software, revised rights that grant greater access may be sent to the user. Information about these changes in rights may be fed back to the sender of the digital asset.

The document that describes the recipient's digital rights may contain, for example, a description of the content of the digital asset, a rights section, and a tracking section. The description of the content may include information about the originator and the format of the content, information about the sender's authority to transmit the content, and information about how the recipient can purchase the content.

In general, the rights section includes a description of who is authorized to change the rights as well as the rights themselves. Digital rights transfer techniques may be implemented through use of the rights section's ability to indicate who is authorized to change the rights. For example, in a corporate structure, widely distributed materials (e.g., corporate financial results) may be distributed with very limited rights, but with the ability to change the rights being transferred to certain recipients. For example, a vice president of a corporation may distribute materials about a corporate initiative to all corporate employees, but with all the recipients being given the ability to only view the materials once, and to make no other use of them. The rights document accompanying the materials, in addition to providing for the limited usage rights, may transfer the ability to change the associated rights to the vice president's superiors (e.g., the CEO), and thereby give them the ability to make unrestricted use of the materials. Though similar results could be achieved by having the vice president distribute the materials to different parties with different rights allocations, digital rights transfer drastically simplifies the distribution process.

Finally, the tracking section includes a description of aspects of use of the content that the sender or the originator wants to track. For example, a sender may indicate that the sender wants to receive a notification each time that the recipient accesses the third page of document embodied in the digital asset. The document may be a XML document.

The server may maintain a “virtual database” of digital assets and may use the database in implementing functions such as data mining, tracking, and monitoring of rights consumption jointly referred to as “digital asset logistics”). To this end, the server may keep a copy of the document that describes the recipient's digital rights. The server may use the document in implementing the digital assets logistics functions noted above. For the server to make use of the document for tracking and other purposes, the recipient must provide feedback about use of the digital asset. To force such feedback to occur, the rights associated with the digital asset may require different levels of connectivity. For example, in one implementation, the rights may indicate that a live connection with the server is required for use of the digital asset, that local rights expire after a certain number of days in which there is no connection to the server, or that local rights continue indefinitely. The sender and/or the originator of the digital content may view the tracking information at a web site associated with the server, or through a secure communications connection to the server.

The systems and techniques provide for using multi-layer encryption to deliver a digital asset (e.g., text, music, video, or software) to an authenticated user, and to locally track the user's activities with respect to the digital asset. This is in contrast to techniques that permit authenticated users to access a central database of digital assets and track the users' activities in the central database. By securing the digital asset and information about its use at the recipient's location, the systems and techniques prevent unauthorized access to other digital assets or their activity information that could occur if a user obtained unauthorized access to the central database (i.e., the systems and techniques do not expose a central database or other collection of digital assets or usage information to attack by unauthorized parties).

In many implementations, the systems and techniques provide superior control and management of digital assets by combining the advantages offered by a proprietary network, a proprietary data deployment protocol, and digital rights management (“DRM”). This enables the use of features such as dynamic DRM using multi-level encryption in which a second layer of encryption encrypts user rights, dynamic DRM with automatic feedback of rights changes to the originator, and tracking of activity information for use in distributing upgrades, improving distribution channels, monitoring pricing structures and sales cycle, and other issues. The ability to track user activity permits implementation and tracking of mass distributions of digital assets to multiple users. By tracking and storing the different users' activities with respect to the distributed digital assets, systems can provide intelligent services such as determining when to upgrade the digital asset and collecting demographic information about use and pricing of the digital asset. For example, a digital asset could be distributed to different users using different pricing structures (e.g., different costs per use, charges based on duration of use, or flat fee charges), and the users' activities could be tracked to determine the most profitable pricing structure.

The tracking techniques may be employed to implement “super-distributions” in which users to which a digital asset is distributed are authorized to redistribute the digital asset to other users (though perhaps with more limited rights). In one example, recipients of a digital asset (e.g., a piece of software) may be authorized to distribute restricted versions of the digital asset to subsequent users who then may purchase greater access to the digital asset. In another example, a recipient of a digital asset may be given the capability of forwarding the digital asset to other recipients with a more restricted set of rights that bars the other recipients from further forwarding the digital asset.

Software may be distributed and controlled without modification of the original executable embodying the software. This may be achieved, for example, through protecting the software's initial variables and through use of a customized loader that interacts with an encrypted executable file.

Though a central database is not used to provide access to digital assets, a central digital rights database may be used to control use of distributed digital assets. For example, as noted above, a recipient may be required to access the central rights database to make use of protected information. Similarly, event-driven synchronization with the central database may be used to track use and rights consumption (or rights revocation). As an alternative, rights may be stored locally but separately from the digital asset with a link to the digital asset.

The server-based approach to communicating digital assets provides a number of other advantages. For example, it may be used to control digital asset delivery based on the relative geographic locations of the sender and the recipient. An example of this is that the type of encryption may be changed automatically based on the country in which the recipient is located so as to comply with laws directed to controlling encryption technology. Thus, the digital asset would be encrypted based on the sender's location, decrypted at the server, and then encrypted at an encryption level appropriate for the recipient.

The systems and techniques also may be used to provide a collaboration system in which a new encryption layer is added each time that a collaborator modifies a document or other digital asset. The original document is maintained in an encrypted format, and is surrounded by subsequent layers of encrypted modifications, with each layer being associated with a different collaborator. Thus, as a document proceeds through multiple iterations, an “onion skin” effect of multiple encryption layers is created. This approach supports “virtual” edits by storing, encrypting, and attaching changes, and automatically feeding those changes back to the original document creator (as well as to other collaborators, where appropriate). Changes associated with different collaborators may be presented using different colors, fonts, or surrounding characters or symbols. Each user may be assigned different editing rights and different rights regarding access to changes by others. In another implementation of the collaboration system, digital signatures that confirm whether a digital asset may be employed instead of or in addition to the encryption techniques.

In another implementation, a digital asset may be packaged using a file protection system that contains the digital asset, the associated viewer, and the associated rights. The file protection system is in the form of, for example, an executable file, and includes all elements necessary to permit only controlled access to the digital asset. When the file protection system is employed, the digital asset does not need to be transmitted using a secure communications channel. The file protection system may be invoked automatically through a user interface in which a digital asset is dragged to and released on a file protection icon that automatically generates a protected version of the digital asset. Thus, the file protection system provides automated protection and requires no special software or coding. In some implementations, the file protection system may be configured to permit no copying of the protected digital asset beyond the original transmission to the recipient. In addition, the file protection system may be configured to associate the protected digital asset with a particular computer or network to which the protected digital asset is sent so that the protected digital asset will be unusable if copied to another computer or network.

In one general aspect, controlling and managing a digital asset transmitted from a sending computer to a receiving computer includes establishing a first secure communication pathway between the sending computer and an intermediate server, transmitting the digital asset from the sending computer to the intermediate server using the first secure communication pathway, establishing a second secure communication pathway between the receiving computer and the intermediate server, and transmitting the digital asset from the intermediate server to the receiving computer using the second secure communication pathway. Rights defining how the digital asset may be manipulated are also transmitted to the receiving computer, and the digital asset is stored at the receiving computer in a way that permits manipulation of the digital asset only in ways that are consistent with the transmitted rights.

Implementations may include one or more of the following features. For example, the digital asset may be stored in a way that only permits the digital asset to be manipulated using an associated viewer.

The rights may be stored in a rights document, such as an XML document, that is transmitted to the receiving computer. The rights document may include information about a viewer to be used in accessing the digital asset, a party who originated the digital asset, the authority of the sending computer to transmit the digital asset, how to purchase the digital asset or rights to use the digital asset, who is authorized to modify the rights defined in the rights document, and aspects of use of the digital asset to be tracked. The rights document may be transferred to the receiving computer using the second secure communication pathway.

The rights may be loaded into a secure database at the receiving computer, and a viewer used to manipulate the digital asset may interact with the secure database when accessing the digital asset to ensure that the digital asset is manipulated consistently with the rights granted for manipulating the digital asset. The rights may control the ability of a user of the receiving computer to copy, view, print, execute, and modify the digital content.

The rights may be modified by transmitting to the receiving computer a replacement set of rights or changes to the rights. The sending computer may be sent a notification that the rights have been modified. When rights include information identifying a viewer to be used in manipulating the digital asset, modifying the rights may include modifying the information identifying the viewer to change the viewer to be used in manipulating the digital asset. Rights modification may be used to implement an asset recall function by modifying the rights defining how the digital asset may be manipulated to prevent a user of the receiving computer from manipulating the digital asset in any way. The asset recall function also may include deleting the digital asset from the receiving computer.

A digital asset database may be maintained at the intermediate server, with the digital asset database including information identifying the digital asset and the rights transmitted to the receiving computer. Feedback may be provided from the receiving computer to the intermediate server about use of the digital asset, and the digital asset database may be updated in response to the feedback. The rights may indicate how feedback to the intermediate server is to be provided. For example, the rights may permit manipulation of the digital asset only when there is a live connection with the intermediate server or only when the time since the last connection with the intermediate server is less than a predetermined value.

The sending computer may be permitted to access information in the digital asset database about the receiving computer's use of the digital asset. The sending computer may use this information to determine when to offer a modification of the digital asset, in collecting demographic information about use and pricing of the digital asset, or in other ways.

The receiving computer may initiate feedback to the intermediate server in response to a particular manipulation of the digital asset, where the particular manipulation may be identified by the rights. The feedback may include, for example, tracking consumption of the digital rights, tracking individual manipulations of the digital asset, or tracking characteristics of individual portions of the digital asset.

The digital asset may be stored in an encrypted format, and manipulating the digital asset may include decrypting the digital asset. Decrypting the digital asset may include retrieving a key from the intermediate server and using the key in decrypting the digital asset. The key also may be stored at the receiving computer in conjunction with the rights and/or the digital asset. In general, storage of the key at the intermediate server provides a higher level of security. The decision about where to store the key may be made, for example, by the sender of by a provider of the digital asset.

In another general aspect, controlling and managing a digital asset installed on a computer includes installing on the computer rights defining how the digital asset may be manipulated by loading the rights into a secure database at the computer. The digital asset is stored in a way that permits manipulation of the digital asset only in ways that are consistent with the installed rights.

Implementations may include one or more of the features noted above or one or more of the following features. For example, the digital asset may be stored in a way that only permits the digital asset to be manipulated using an associated viewer that interacts with the secure database when accessing the digital asset to ensure that the digital asset is manipulated consistently with the rights granted for manipulating the digital asset.

A digital asset database maintained at a remote server may include information identifying the digital asset and the rights installed at the computer. Feedback may be provided from the computer to the remote server about use of the digital asset, and the digital asset database may be updated in response to the feedback. The rights may indicate how feedback to the remote server is to be provided.

In another general aspect, controlling and managing a digital asset transmitted from a sender to multiple recipients includes transmitting the digital asset from the sender to the recipients, and transmitting to the recipients rights defining how the digital asset may be manipulated. The digital asset is stored in storage locations associated with the recipients in a way that permits manipulation of the digital asset only in ways that are consistent with the transmitted rights, and certain ones of the recipients are permitted to modify the rights defining how the certain ones of the recipients may manipulate the digital asset.

Implementations may include one or more of the features noted above or one or more of the following features. For example, the transmitted rights may permit each recipient to manipulate the digital asset in the same way, and may indicate which recipients may modify the rights or one or more classes of recipients that may modify the rights. Certain ones of the recipients may be permitted to transmit the digital asset to other recipients and to control the rights transmitted to the other recipients.

In another general aspect, controlling and managing a digital asset transmitted from a sender to a recipient includes transmitting the digital asset from the sender to the recipient and transmitting to the recipient a first set of rights defining how the digital asset may be manipulated. The digital asset is stored in a storage location associated with the recipient in a way that permits manipulation of the digital asset only in ways that are consistent with the transmitted rights. The recipient is permitted to transmit the digital asset to another recipient along with a second set of rights defining how the digital asset may be manipulated by the other recipient. The second set of rights may be more restrictive than the first set of rights.

In another general aspect, a system for dynamically managing digital rights of digital content may include a digital content package comprising digital content data and a digital rights manager wherein the digital content data includes encrypted data, and a digital rights database operable to store digital rights relating to the digital content data. The digital rights manager includes code that is operable to determine whether digital rights to manipulate the digital content data exist in the digital rights database, and decrypt the encrypted data of the digital content data to generate decrypted digital content that can be manipulated.

The system may further include a computer device operable to manipulate the decrypted digital content, and a global rights unit operable to manage the digital rights database and communicate with the computer device. The global rights unit may be located remotely from the computer device. The global rights unit may include a global clock and may be operable to synchronize a local clock of the computer device with the global clock when a communication link between the computer device and the global rights unit is available.

The digital rights manager may be operable to decrypt the encrypted data of the digital content only if the digital rights to manipulate the digital content data exist in the digital rights database. The decrypted digital content may include an executable file that is operable to run on the computer device. The digital content package may include a viewer module having viewer code operable to facilitate manipulation of the decrypted content on a computer device.

The digital rights database may include a local digital rights database file stored at a computer device an including individual digital rights information related to an individual digital content package, and a global digital rights database located at the global rights unit comprising digital rights information related to multiple digital content packages. The local digital rights database and the global digital rights database may be operable use a communication pathway to harmonize the databases with each other or to have one database modify data in the other. The digital rights to manipulate the digital content data may be modified automatically each time the digital content data is manipulated or according to time-based criteria.

The system also may include a tracking manager module operable to gather tracking information concerning the digital content data from the digital rights database. The tracking manager module may be further operable to manipulate the tracking information concerning the digital content data. Different copies of the digital content data may include a unique identifier operable to distinguish the copies of the digital content data from each other, and the tracking information concerning the digital content data may include routing information of individual copies of the digital content data, identities of computer devices at which the individual copies of the digital content data reside, and the number of copies of the digital content data in existence.

In another general aspect, providing secure collaboration among several collaborators may include providing a digital asset to a collaborator in an encrypted format, permitting the collaborator to edit the digital asset using an authorized viewer program, and saving changes made by the collaborator in an encrypted format by creating a collaboration file by encrypting a change document representing the changes made by the collaborator and the original encrypted digital asset.

Implementations may include one or more of the features noted above or one or more of the following features. For example, the collaboration file may be provided to another collaborator who is permitted to edit the digital asset using an authorized viewer program and the collaboration file. Changes made by the other collaborator may be saved in an encrypted format by creating a second collaboration file by encrypting a second change document representing the changes made by the other collaborator and the collaboration file such that a second encryption layer is added by the other collaborator.

The other collaborator may be presented with the digital asset and the changes made by the first collaborator in a way that distinguishes the original digital asset from the changes made by the first collaborator. For example, the digital asset may be presented using a font or color different from a font used to present the changes made by the first collaborator.

Different collaborators may be given different rights with respect to editing the digital asset, and with respect to viewing changes made by other collaborators. Changes may be provided to an entity that provided the digital asset to the collaborator.

In another general aspect, managing digital rights of software on a computer system includes encrypting at least a portion of an executable file to generate an encrypted executable file, writing the encrypted executable file to a host location on the computer system during installation of software including the encrypted executable file, and providing a loader for the encrypted executable file. The loader is operable to authenticate the encrypted executable file and cause the encrypted executable file to run on the computer system.

The portion of the executable file may include initial variables of the executable file.

Execution of the encrypted executable file may include authenticating the encrypted executable file, writing the encrypted executable file to a memory location of the computer system, decrypting the portion of the encrypted executable file, and running the decrypted portion of the encrypted executable file. Authenticating the encrypted executable file may include confirming that rights in a rights document are satisfied. that rights in a rights document have been satisfied may include determining whether the computer system is an authorized computer system on which the software is authorized to be installed. The rights document may be appended to the encrypted executable file, and may be an extensible markup language (XML) file.

The authenticating, writing and decrypting may be performed by the loader. Authenticating the encrypted executable file may include determining whether the encrypted executable file may be executed on the computer system, and accessing a central rights database through a communication pathway associated with the computer system. The central rights database may be managed through a remotely located server by, for example, modifying usage rights of the software. The communication pathway may include an Internet connection.

Usage of the software may be tracked by, for example, gathering information about the usage of the software through a communication pathway associated with the computer system. The executable file may be configured to be executed through only the loader. The loader may include software code specifically written to authenticate, load, decrypt and execute the encrypted executable file in a manner transparent to an end-user. The executable file may include an executable binary file.

The executable file may include a header portion, a code portion and a data portion. Encrypting at least a portion of the executable file may include encrypting at least one of the code portion and the data portion.

In another general aspect, a system for managing digital rights of software includes a computer including a communication device operable to communicate, through a communication pathway, with other electronic devices that are remote from the computer, a remote authentication device in communication with the communication device via the communication pathway, and software operable to be installed and run on the computer. The software includes an executable file and an authentication loader program operable to authenticate and enable running of the executable file. The software is structured and arranged such that installation of the software is accomplished based on whether the remote authentication device permits the software to be installed on the computer, and running of the software is accomplished based on whether the authentication loader program permits the software to be run on the computer.

The computer may include a memory storage device operable to store digital information including the software, and a random access memory unit. The system may further include a software installer program operable, based on whether the remote authentication device permits the software to be installed on the computer, to encrypt at least a portion of an executable file of the software, thereby generating an encrypted executable file, append the authentication loader program to the encrypted executable file, and write the authentication loader program and the encrypted executable file to the memory storage device of the computer.

When the computer includes a memory storage device operable to store digital information including the software and a random access memory unit, the authentication loader program may be operable to determine whether the executable file may be executed on the computer by authenticating the executable file, read the executable file from the memory storage device of the computer, identify a memory space in the random access memory unit for the executable file, write the executable file to the memory space for execution, and start the executable file of the software running. When at least a portion of an executable file of the software is encrypted, the authentication loader program may be further operable to decrypt the portion of the executable file that is encrypted before starting the executable file of the software running. The authentication loader program starts the executable file of the software running immediately after decrypting the portion of the executable file that is encrypted.

When the remote authentication device is a server that manages a digital rights database, the authentication loader program may include code for causing the computer to access the remote authentication device to determine whether digital rights exist to run the software on the computer. The authentication loader program may include code for authenticating the executable file by confirming that rights in a rights document, which may be an XML document, are satisfied. The rights document may be appended to the executable file and encrypted. The code for confirming that rights in the rights document are satisfied may be operable to determine whether the computer is an authorized computer on which the software is authorized to be installed.

The remote authentication device may include a server that manages a digital rights database including digital rights relating to the software. The digital rights may include a number of times a particular copy of the software is permitted to be installed, and the digital rights database may be accessed during installation of the software. The remote authentication device may be operable to automatically decrement the number of times the particular copy of the software is permitted to be installed when the digital rights database is accessed during installation of the software.

The digital rights may include a number of times a particular installed copy of the software is permitted to be manipulated. The digital rights database may be accessed by the authentication loader program during authentication of the executable file, and the remote authentication device may be operable to automatically decrement the number of times the particular installed copy of the software is permitted to be manipulated when the digital rights database is accessed during authentication of the executable file.

The remote authentication device may be operable to automatically modify the digital rights according to programmed criteria, and may include an interface through which the digital rights are modified by human intervention.

The system also may include a software usage tracking unit operable to gather and record information about usage of the software. Information about the usage of the software may include a number of times a particular copy of the software is installed, identities of computers onto which a particular copy of the software is installed or is attempted to be installed, and a number of times a particular copy of the software is run.

The communication pathway may include an Internet connection. Each installation of the software may be unique, such that a duplicated copy of installed software will not run properly. However, the remote authentication device may permit an authorized backup copy of the software to function properly. The remote authentication device may include a server that manages a digital rights database that includes information about installation rights of individual copies of the software.

In another general aspect, managing digital rights during installation of software on a computer system includes accessing a digital rights database to determine whether the software is permitted to be installed on the computer system. Thereafter, based on whether the software is permitted to be installed on the computer system, an installation program encrypts at least a portion of an executable file to produce an encrypted executable file, appends a loader to the encrypted executable file, and writes the loader and the encrypted executable file to a host storage location on the computer system.

A number of times a particular copy of the software is installed may be tracked. An identity of the computer system onto which a particular copy of the software is installed or is attempted to be installed may be logged. The digital rights database includes information about installation rights of individual copies of the software.

The installation program may be configured such that duplicated copies of the installation program do not function properly. The software on the computer system may be installed in a manner unique from other copies of the software installed on other computer systems such that a copy of the software installed on a first computer system will not work properly on a second computer system. However, the digital rights database may permit the authorized backup copy of the software to function properly.

Accessing a digital rights database may include communicating between the computer system and the digital rights database through a communication pathway associated with the computer system. The communication pathway may include an Internet connection.

The digital rights database may include an encrypted computer file located on the computer system.

The digital rights database may be managed on a server remotely located from the computer system. Managing the digital rights database may include modifying digital rights of a particular copy of the software. The digital rights may include a number of times the particular copy of the software may be installed, and modifying the digital rights of a particular copy of the software may include automatically decrementing the number of times the particular copy of the software may be installed when the central rights database is accessed during installation of the particular copy of the software.

In another general aspect, generating a protected version of a digital asset includes encrypting the digital asset, generating a set of rights for controlling use of the digital asset, and associating the encrypted digital asset, the generated set of rights, and a viewer program to create the protected version of the digital asset.

A user interface including an icon representing a program for generating the protected version of the digital asset may be presented on a computer, and the encrypting, generating, and associating may be performed in response to moving an icon representing the digital asset to the icon representing the program for generating the protected version of the digital asset. Associating the encrypted digital asset, the generated set of rights, and the viewer program may include generating an executable file including the encrypted digital asset, the generated set of rights, and the viewer program.

The protected version of the digital asset may be transferred to a recipient. The digital rights may prevent an entity other than the recipient from accessing the digital asset, and may prevent the digital asset from being accessed using a computer other than a particular computer associated with the recipient.

In another general aspect, generating and manipulating a protected version of a digital asset includes encrypting the digital asset, generating a set of rights for controlling use of the digital asset, associating the encrypted digital asset, the generated set of rights, and a viewer program to create the protected version of the digital asset, transmitting the protected version of the digital asset to a recipient, authorizing manipulation of the digital asset by confirming that the generated set of rights allow manipulation of the digital asset, decrypting the encrypted digital asset if the generated set of rights allow manipulation of the digital asset, and allowing manipulation of the decrypted digital asset only within limits defined by the generated set of rights.

A viewer program associated with the digital asset may be used to authorize manipulation of the digital asset, decrypt the encrypted digital asset, and allow manipulation of the decrypted digital. Authorizing manipulation of the digital asset may include authenticating a computer system on which a recipient is attempting to manipulate the digital asset, and communicating with a remotely located global rights management unit to authenticate the recipeint and/or a computer system on which the recipient is attempting to manipulate the digital asset. Tracking data may be communicated to the global rights management unit each time that the recipient attempts to manipulate the digital asset. The tracking data may include at least one of an identity of a computer system on which the digital asset is being hosted, a location of the computer system, a time that the digital asset was received, a time that manipulation of the digital asset is attempted, and a manner of manipulation of the digital asset that is being attempted.

The generated set of rights may allow the recipient to forward the digital asset to another recipient with full rights to manipulate the digital asset, may prevent all manipulation of the digital asset by another recipient if the recipient to which the digital asset was originally transmitted forwards the digital asset to the other recipient, may prevent the manipulation of the digital asset if the digital asset is copied, and may allow the digital asset to be manipulated only once on any given computer system.

A graphical user interface at a transmitting side may be used to select rights to include in the generated set of rights prior to transmitting the protected version of the digital asset to the recipient.

The viewer program may include a graphical user interface that allows the recipient to control manipulation of the decrypted digital content. An upgrade graphical button may be provided as part of the graphical user interface, and the digital asset may be updated upon actuation of the upgrade graphical button by communicating upgrade data for the digital asset to the recipient if the upgrade data is available and if such upgrading is defined in the generated set of rights.

Other features and advantages will be apparent from the following description and drawings, and from the claims.

### DESCRIPTION OF DRAWINGS

FIG. 1 is a block diagram of a system for controlling and managing digital assets.

FIG. 2 is a flow diagram showing the flow of digital information between elements of the system of FIG. 1.

FIG. 3 is a block diagram of an exemplary system for dynamically managing rights associated with digital content.

FIG. 4 is a block diagram of an exemplary digital content package for distribution to and manipulation on computer devices.

FIG. 5 is a flow chart of an exemplary process for dynamically managing digital rights to manipulate digital content in the system of FIG. 3.

FIG. 6 is a flow chart of an exemplary process for dynamically managing digital rights to track digital content in the system of FIG. 3.

FIG. 7 is a flow chart of an exemplary process for modifying digital rights to manipulate digital content in the system of FIG. 3.

FIGS. 8A and 8B are block diagrams of exemplary structures of an executable portion of digital-rights-manageable software installed on the system of FIG. 3.

FIG. 9 is a flow chart of an exemplary process for installing software on the system of FIG. 3.

FIG. 10 is a flow chart of an exemplary process for running software on the system of FIG. 1.

FIG. 11 is a diagram illustrating exemplary software modules for generating a collaboration message.

FIG. 12 is a diagram illustrating an exemplary collaboration message generated by the modules of FIG. 11.

FIG. 13 is a diagram illustrating an exemplary process performed by a recipient of a collaboration message generated by the modules of FIG. 11.

FIG. 14 is a diagram illustrating exemplary software modules for processing collaboration messages.

FIG. 15 is a diagram illustrating exemplary layered software including the software modules of FIG. 14 installed on a receiving system.

FIG. 16 is a flow chart illustrating an exemplary process by which the software modules of FIG. 14 store collaboration messages in a storage device.

FIG. 17 is a flow chart illustrating an exemplary process by which the software modules of FIG. 5a read messages from the storage device.

FIG. 18 is a block diagram illustrating an exemplary file protection system.

FIG. 19 illustrates an exemplary graphical user interface useful in enabling the file protection system of FIG. 18.

FIG. 20 illustrates an exemplary graphical user interface useful in enabling the file protection system of FIG. 18.

FIG. 21 illustrates an exemplary graphical user interface useful in enabling the file protection system of FIG. 18.

FIG. 22 illustrates an exemplary graphical user interface useful in enabling the file protection system of FIG. 18.

Like reference symbols in the various drawings indicate like elements.

### DETAILED DESCRIPTION

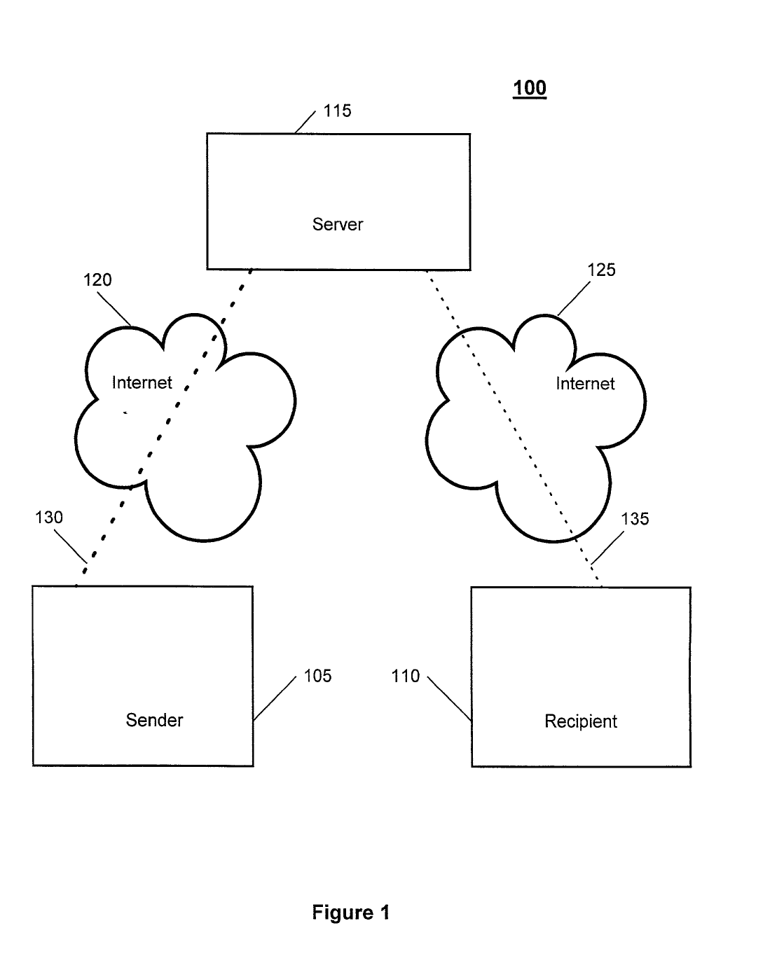

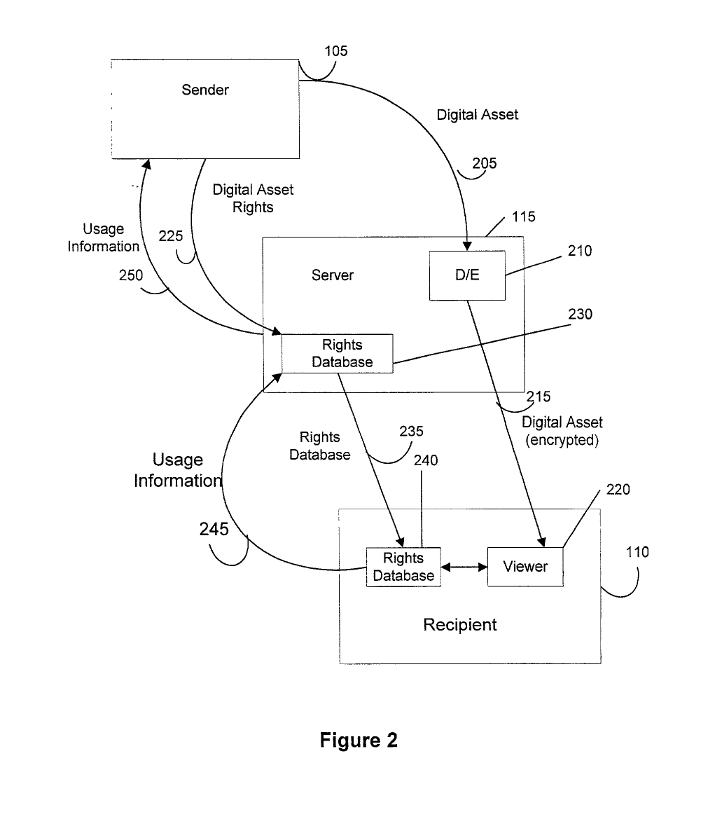

Referring to FIG. 1, a system 100 permits a sender 105 to transmit a digital asset to a recipient 110 using an intermediate server 115. The sender 105 and the recipient 110 are connected to the server 115 through networks 120, 125. Networks 120, 125 may include, for example, the Internet, a wide area network, a local area network, a wired or wireless telephone system, or any other communication channel. The system 100 employs encrypted communications between the sender, the recipient, and the server such that, as shown in FIG. 2, a secure communication channel 130 is established between the sender 105 and the server 115 through the network 120, and a secure communication channel 135 is established between the recipient 110 and the server 115 through the network 125. Typically, the sender and the server (or the recipient and the server) use a handshaking technique that employs public key encryption to generate a session key that then is used in providing communications using the secure communication channel 130 (or the secure communication channel 135).

FIG. 2 illustrates how a digital asset and related information flows between the elements of the system of FIG. 1. Initially, the sender 105 uses the secure communication channel 130 to transmit a digital asset to the server 115 (step 205). Thus, the digital asset is transmitted to the server in an encrypted format, with the encryption employing the sender/server session key.

An encryption/decryption module 210 at the server 115 receives the digital asset, decrypts it, and re-encrypts it for transmission to the recipient 110 (step 215). Transmission to the recipient may employ the secure communications channel 135, with the secure server providing a second layer of encryption using the recipient/server session key, or may employ a channel that is not secure and instead relies on the encryption provided by the module 210 to protect the digital asset. In some implementations, the module 210 may use the recipient/server session key to encrypt the digital asset, such that using the secure communications channel 135 does not impose a second layer of encryption. Regardless of which approach is used, the digital asset is received and maintained at the recipient in an encrypted format that only permits a viewer 220 at the recipient to access and manipulate the digital asset.

The sender 105 also sends the server 115 information about the rights in the digital asset that the recipient 110 is to be provided (step 225). The sender may send this rights information before, after, or with the digital asset. In general, the rights information is sent in an encrypted format using the secure communications channel 130. In one implementation, the rights information is sent in the form of an XML-document that includes a description of the content of the digital asset, a rights section, and a tracking section. The description of the content includes information about the sender and the format of the digital asset (e.g., information that identifies a viewer to be associated with the digital asset), information about the sender's authority to transmit the content, and information about how the recipient can purchase the content. In general, the rights section includes a description of who is authorized to change the rights as well as the rights themselves. Finally, the tracking section includes a description of the aspects of use of the content that the sender wants to track.

The server stores the received rights information in a central rights database 230, and transmits the rights to the recipient in an encrypted format using the secure communication channel 135 (step 235). Upon receiving the rights information, the recipient stores it in a secure rights database 240. Thereafter, the viewer 240 communicates with the rights database 240 whenever the user at the recipient wants to access or manipulate the digital asset, and only permits the user to access or manipulate the digital asset in ways that are consistent with the rights recorded in the rights database 240.

When the digital asset is encrypted, manipulation of the digital asset generally includes decrypting the digital asset using a decryption key. This decryption key may be stored locally, or may be retrieved from the server. In either case, the decryption key generally is stored in a protected format so that the decryption key cannot be accessed until the recipient and/or the user at the recipient have been authenticated and a determination has been made that the desired manipulation of the digital asset is in compliance with the rights stored in the rights database.

When the user accesses or manipulates the digital asset, the recipient may send usage information back to the central rights database at the server (step 245). The server updates the rights database 230 using this usage information. The server also may transmit the usage information to the sender (step 250).

The digital rights may be modified by the sender or a third party authorized by the sender (i.e., a third party to whom the sender has transferred digital rights). In general, this is accomplished by having the server transmit an updated digital rights document to the recipient. The rights controlled may relate to, for example, copying, viewing, printing, executing, and modifying the digital content.

The ability to modify the digital rights permits implementation of a number of functions. For example, a recall function that recalls a previously-transmitted digital asset may be implemented by sending revised digital rights that revoke all of the recipient's rights to access the digital asset and, in some instances, delete the digital asset from the recipient's computer.

The ability to modify the digital rights also provides a mechanism to automatically upgrade the system. For example, if an improved viewer having enhanced security or other properties is released, users can be forced to transition to the new viewer by modifying the digital rights to require use of the new viewer.

Use of the connection between the rights database at the recipient and the central rights database permits monitoring of the digital content after distribution of the digital content. This monitoring can take several forms, including tracking consumption of the available digital rights, tracking individual manipulations of the digital content, and/or tracking characteristics of individual copies or portions of the digital content.

An overview of the systems and techniques has been provided with respect to FIGS. 1 and 2. Several particular implementations now will be described.

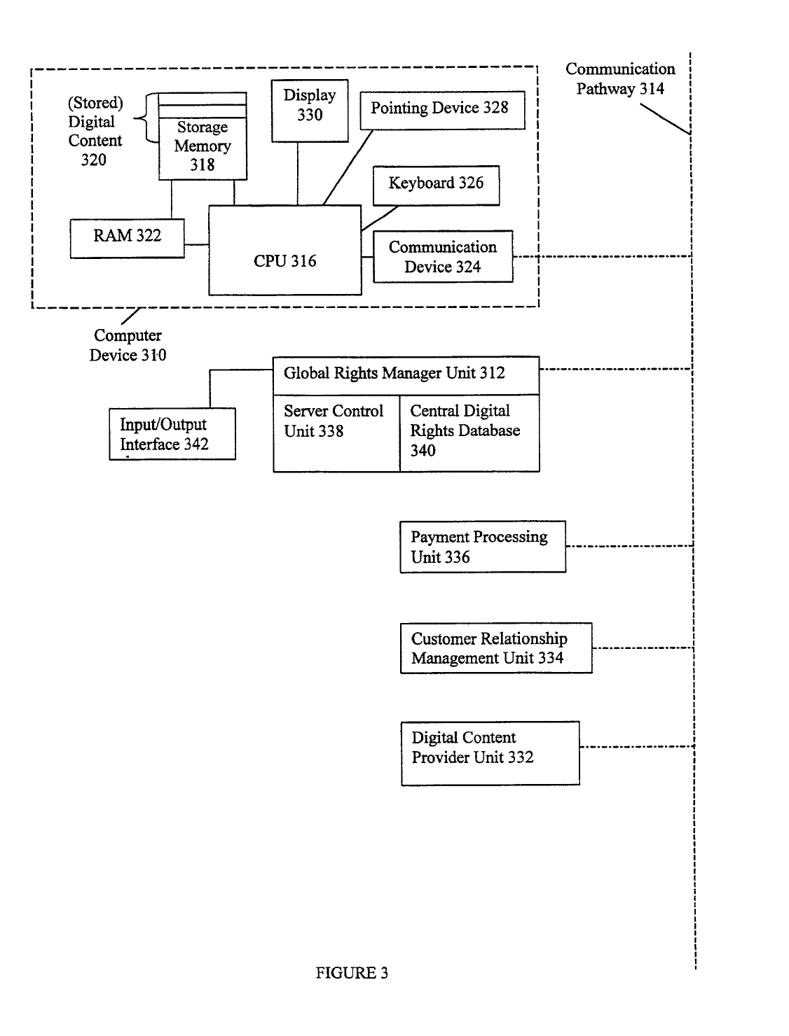

FIG. 3 shows a computer device 310 (e.g., the recipient 110) in communication with a server-based global rights manager unit 312 (e.g., the central rights database 230) via a communication pathway 314. Additional computer devices, servers, and other electronic devices can be in communication with the communication pathway 314. The exemplary computer device 310 includes a central processing unit (CPU) 316, a storage memory 318 for storing, for example, digital content 320 (i.e., a digital asset), a random access memory (RAM) 322, and a communication device 324 for communicating with other devices using the communication pathway 314. The computer device 310 also includes various input and output devices, such as a keyboard 326, a pointing device 328 (e.g., a mouse), and a display 330.

The terms “computer,” “computer device” and “computer system,” as used throughout this disclosure, can and should include all forms of programmable and/or code-driven devices, such as a personal computer (e.g., the 8086 family and Pentium series devices), a thin-client device, a Macintosh computer, a Windows-based terminal, a network computer, a wireless device, an information appliance, a RISC Power PC, a X-device, a workstation, a mini computer, a main frame computer, an electronic handheld information device (e.g., a personal digital assistant (PDA)), or another computing device. Most often, these programmable and/or code-driven devices use a graphical user interface (GUI) to facilitate operation. For example, a common type of GUI is a windows-based interface. Windows-based GUI platforms supported by these programmable and/or code-driven devices can include, for example, Windows 95, Windows 98, Windows 2000, Windows NT 3.5 1, Windows NT 4.0, Windows CE, Windows CE for windows-based terminals, Macintosh, Java, and Unix.

The system illustrated in FIG. 3 also includes a digital content provider unit 332, a customer relationship management (CRM) unit 334, and a payment processing unit 336. Furthermore, it should be recognized that the individual units depicted in FIG. 3 can be selectively combined with each other, or deleted. For example, the customer relationship management unit 334, the payment processing unit 336, and the global rights manager unit 312 can be combined to form a single unit for updating and managing digital rights and tracking the usage of the digital content 320.

The global rights manager unit 312 includes a server controller unit 338 and a central digital rights database 340, which can be implemented by various forms of electronic data storage devices and/or operating software. The global rights manager unit 312 is capable of managing the central digital rights database 340, the public and private keys used for authenticating and/or encrypting/decrypting the digital content 320, and histories of digital content usage and manipulation and digital rights consumption and modification. Furthermore, the global rights manager unit 312 is capable of mining/gathering data associated with the digital content 320 for tracking purposes.

The global rights manager unit 312 can be located at the user's location, or at a location remote from the user such as a central data center. For example, the global rights manager unit 312 may take the form of a remotely located secure server, which can be protected from electronic and physical intrusion and safeguarded against failure by redundant data storage and power supplies. The global rights manager unit 312 also may take the form of an electronic virtual warehouse that can store, transfer, and direct the digital content 320 and the associated digital rights to particular end-users.

The central digital rights database 340 contains a database of digital rights, which may include digital rights capable of controlling, for example, the number of times the digital content can be manipulated (e.g., installed, run, modified, viewed, heard, printed, copied, forwarded), whether one or more legitimate backup copies of the digital content can be made, which users or machines can manipulate the digital content, whether an attempt to re-manipulate the digital content after a computer failure is allowed, whether copies or printouts are authorized and whether and what duration and time usage limits will be imposed. Moreover, the digital rights may include controlling the ability of digital content forwarded to another end-user or computer device to be manipulated, even if, for example, the digital rights to manipulate the digital content on the forwarding computer have expired. Additionally, the digital rights may include controlling viewing options (e.g., full screen or window-sized) of the digital content, printing options, modification of the digital content, and the duration of manipulation capabilities (e.g., available after or until a certain date, or for a certain period of time). In addition, as discussed above, the digital rights may implement digital rights transfer by controlling who is authorized to modify the digital rights.

Regarding the storage of the digital rights data, the central digital rights database 340 can be maintained such that digital rights can be updated and/or revoked automatically (e.g., after passage of time, or as a number of installations of the digital content occurs) or through human intervention using, for example, input/output interface 342 (e.g., an administrator can manually update or revoke digital rights by modifying the data in the central digital rights database 340). The digital rights for a particular copy of digital content 320 can be created by the global rights manager unit 312, or, for example, sent to the global rights manager unit 312 by the digital content provider unit 332 when the digital content 320 is delivered to the end-user's computer device 310.

The digital content provider unit 332 can provide digital content 320 directly to the end-user's computer device 310 through the communication pathway 314. Alternatively, the end-user may be required to purchase the digital content 320, for example, through the payment processing unit 336, before the digital content 320 is sent to the computer device 310. The payment processing unit 336 also may be used for purchasing additional digital rights to manipulate the digital content 320 when the end-user desires additional rights. Moreover, the global rights manager unit may require authentication of the computer device 310 using a digital certificate or some other identifying means before digital content 320 is provided to the computer device.

Alternatively, the digital content provider unit 332 can post the digital content 320 on a server or servers and allow any end-user to download the digital content 320. Furthermore, depending on the digital rights defined for a particular copy or form of digital content 320, the end-user may be able to forward the digital content 320 to other end-users, who in turn may be able to forward the digital content 320 to other end-users in a manner known as “super-distribution.” As noted above, digital content forwarded using “super-distribution” may have associated digital rights that are the same or more restricted than the digital rights associated with the digital content prior to forwarding. The central digital rights database 340 may maintain an association with each forwarded copy of the digital content so as to track and monitor how each copy is accessed and used. The flexibility of the dynamic digital rights management system allows myriad configurations defining the rights available to end-users to manipulate the digital content 320.

The communication pathway 314 can be wireless, switchably wired, or hardwired between the computer device 310 and the global rights manager unit 312. The communication pathway 314 can be, for example, a local-area network (LAN), an Intranet, or a wide area network (WAN) such as the Internet or the World Wide Web. Each of the computers and server systems can connect to the communication pathway 314 through a variety of connections including standard telephone lines, LAN or WAN links (e.g., T1, T3, 56 kb, and X.25), broadband connections (e.g., ISDN, Frame Relay, and ATM), and wireless connections. The connections can be established using a variety of communication protocols (e.g., HTTP, TCP/IP, IPX, SPX, NetBIOS, Ethernet, RS232, and direct asynchronous connections).

Moreover, a common communication pathway 314 is not necessary, and more than one type of communication pathway 314 can be used to connect the equipment depicted in FIG. 3. For example, a separate communication link between the digital content provider unit 332 and the global rights manager unit 312 can be used.

FIG. 3 illustrates an exemplary configuration that enables delivery of digital content 320 to the end-user through, for example, the Internet or electronic mail. However, digital content 320 also may be delivered through regular mail, or may be acquired from some other form of physical delivery such as a purchase from a store. The digital content 320 can represent an unlimited variety of content, such as, for example, text, files, documents, parcels, multimedia content, video data, images, electronic photographs, executable software, program source code, file folders, audio data, and music. For instance, in the business environment, digital content 320 can include technical specifications, research documents and other forms of intellectual property. In a consumer environment, digital content 320 can include digital goods such as software, movies, and electronic books. Control of the digital rights of these and other forms of delivered digital content 320 after receipt by a user is one primary focus of digital rights management.

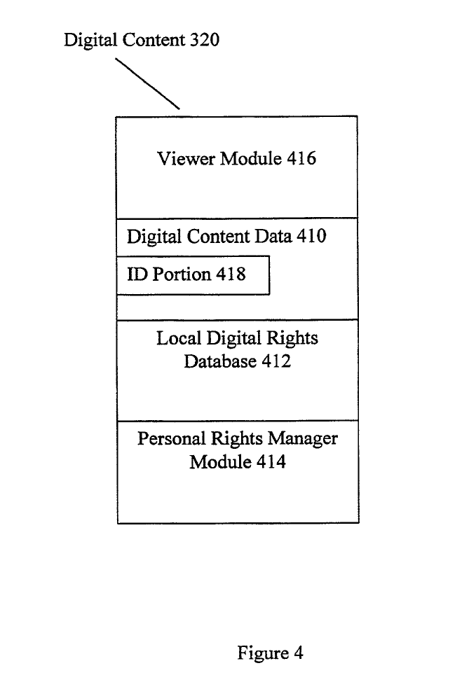

FIG. 4 shows an exemplary package of digital content 320 that can be delivered to the computer device 310. The digital content 320 may be associated with a local digital rights database 412 for storing digital rights related to the digital content 320, a personal rights manager module 414 for determining whether digital rights exist to manipulate the digital content 320, and a viewer module 416 for facilitating the manipulation of the digital content 320. Once the local digital rights database 412, the personal rights manager module 414, and the viewer module 416 have been installed at the computer device 310, subsequent packages of digital content may include only the digital content 320 and associated digital rights or, when rights in previously-sent digital content are to be modified or updated, just digital rights.

The digital content 320 and the local digital rights database 412 generally are encrypted to prevent unauthorized tampering with and modification of the digital content 320 and the digital rights associated with the digital content 320. The strength of the encryption algorithm used to encrypt the digital content portions may vary depending on the circumstances. One implementation employs 256-bit encryption or the strongest encryption allowable for the intended purpose (where government regulations may control the encryption strength permitted for certain distributable software).

Digital content 320 may be stored on the storage memory 318 and may be installed or stored on the computer device 310 in the format shown in FIG. 4 or in various other formats, such as randomly writing portions of the digital content 320 in non-contiguous areas of the memory storage 318. Furthermore, the relative orientation of the portions of the digital content 320 may differ from that shown by FIG. 4, and the local digital rights database 412 optionally may be stored remotely from the digital content 320. Indeed, the local digital rights database 412 can be located elsewhere in the storage memory 318, or removed altogether possibly requiring that the personal rights manager module 414 to communicate with, for example, the global rights manager unit 312 to determine whether digital rights exist to manipulate the digital content 320). Moreover, the personal rights manager module 414 may be a separate customized software program that causes the digital content 320 to run on the computer device 310. If some of the files depicted in FIG. 4 are not appended to the personal rights manager module 414 as stored on the computer device 310, the files can be written to the memory 318 in a location separate from the personal rights manager module 414 while maintaining a relationship (e.g., a mapping) to the personal rights manager module 414 in the memory 318. Moreover, the various files can be hidden in memory 318 such that an end-user cannot find them using normal file search methods (e.g., Windows Explorer). However, for simplification, the exemplary format shown in FIG. 4 will be used in this description.

When digital content 320 is created and/or distributed, a content ID and content instance ID may be generated and included in the digital content 320 for use in lifetime identification (e.g., for tracking and security) of the individual copies of the digital content 320. These content IDs can be embedded in the ID portion 418 of the digital content 320, as shown in FIG. 4. As such, each copy of the digital content 320 may have an identification mechanism that is globally unique. Additionally, a content origination ID may be generated and included with the digital content 320, allowing, for example, the global rights manager unit 312 to identify the origin of individual copies of the digital content 320. For example, the global rights manager unit 312 could identify how the digital content 320 first entered the stream of distribution by checking the content origination ID, which could be used to identify whether the digital content 320 was obtained through, for example, a digital storefront, a mass distribution from a particular content provider (e.g., from digital content provider unit 332), or as a forwarded attachment from another end-user.

As shown in FIG. 4, a personal rights manager module 414 may be associated with the digital content 320. This personal rights manager module 414 can be transparently launched when an end-user attempts to manipulate the digital content 320. The personal rights manager module 414 can be used to verify that rights exist to manipulate the particular digital content 320 on the particular computer device 310. This process may include accessing the digital rights database of either or both of the local digital rights database 412 and the central rights database 340 before the end-user is allowed to manipulate the digital content 320. The personal rights manager module 414 may need to decrypt the local digital rights database 412 to check the digital rights for the digital content 320. Once the digital rights to manipulate the digital content 320 are determined, the personal rights manager module 414 can decrypt the digital content 320 to render the digital content 320 ready for manipulation by the end-user.

At any given time, the local digital rights database 412 may include digital rights that are the same as those stored in the central digital rights database 340, or different digital rights, depending, for example, on the consumption of the digital rights at the computer device 310, the modification of the digital rights at the central rights database 340, and the frequency of synchronization between the central digital rights database 340 and the local digital rights database 412. The local digital rights database 412 may be required to be periodically updated/synchronized with the remotely located central digital rights database 340. Moreover, the system can function with only one of the central digital rights database 340 and the local digital rights database 412. However, having both the central digital rights database 340 and the local digital rights database 412 allows for greater flexibility in dynamically managing the digital rights associated with the digital content 320. This dual-database implementation provides portable digital rights management for computer devices 310 that are not always connected to a communication pathway 314 (e.g., a network), and also provides for real-time dynamic digital rights management when the computer device 310 is in communication with the communication pathway 314.

Another implementation relates to a computer device 310 that is not in communication with the central digital rights database 340 for extended periods of time, if at all. In this implementation, the digital content 320 may only be associated with the local digital rights database 412. Preferably, the local digital rights database 412 is stored in encrypted format on the computer device 310, or on media accessible by the computer device 310. To manipulate the digital content 320, the personal rights manager module 414 authenticates the digital content 320 by determining whether digital rights exist in the local digital rights database 412 to manipulate the particular copy of the digital content 320 on that particular computer device 310.

If the computer device 310 is never in communication with the global rights manager unit 312 (and therefore the central digital rights database 340), then the digital rights for the particular copy of the digital content 320 stored on the computer device 310 may expire after the predetermined original digital rights are consumed. Accordingly, the end-user will no longer be able to manipulate the particular copy of the digital content 320 with that particular computer device 310. However, the digital content 320 may be manipulated on another computer device 310 or by another end-user, depending on the digital rights configuration for that individual copy of the digital content 320.

The global rights manager unit 312 or some other electronic device (e.g., a server) connected to the communication pathway 314 may modify the digital rights stored in the local digital rights database 412. This may occur, for example, when the computer device 310 is in communication with the communication pathway 314. This process can take the form of synchronizing the local digital rights database 412 with the central digital rights database 340, or merely updating, modifying, or revoking the digital rights in the local digital rights database 412.

Additionally, the digital rights in either or both of the local digital rights database 412 and the central rights database 340 may be defined by using an extensible markup language (XML), or some other language that is flexible and designed for easy extension. A document describing the digital rights may contain, for example, a description of the content of the digital asset, a rights section, and a tracking section. The description of the content may include information about the originator and the format of the content, information about the sender's authority to transmit the content, and information about how the recipient can purchase the content. In general, the rights section includes a description of who is authorized to change the rights as well as the rights themselves. Digital rights transfer techniques may be implemented through use of the rights section's ability to indicate who is authorized to change the rights. Finally, the tracking section includes a description of aspects of use of the content to be tracked.

The document describing the digital rights provides for an assignment of rights across the entire content or with increasing levels of granularity such as, for example, by page, by file location, or by seconds of a movie. The digital rights description is used by the dynamic digital rights management system to describe the digital content 320, identify the scope and granularity of the specified rights, and identify the usage and consumption patterns to track and provide the information necessary to allow purchase of additional rights. Tracking of the digital content 320 is similarly flexible in terms of extension and granularity.

The viewer module 416 is an optional software module for facilitating the manipulation of the digital content 320. If the digital content is an executable file, a viewer module 416 may not be required. However, if the digital content represents, for example, a digital movie, a digital book, a digital photograph, or other non-executing digital content, then a viewer module 416 may be required to manipulate (e.g., view) the digital content once it is decrypted and ready for manipulation. The viewer module 416 may include software operable to transform different formats of decrypted digital content into usable formats, so that an end-user can manipulate the digital content. For example, usable forms may include viewable, copyable, printable, modifiable, hearable, installable, and executable forms.

Formats of digital content supported by the viewer module 416 may include, for example, Audio Video Interleave (Avi), Wave sound (Wav), Moving Pictures Expert Group (Mpg, M1v, Mp2, Mpa, Mpeg), Mpeg layer 3(Mp3), Quick Time (Qt, Mov), Shockwave Director (Dcr), Macintosh Aiff Resource (Aif, Aifc, Aiff), NetShow (Asf), SunMicrosystems Audio (Au, Snd), RealAudio (Ra), RealVideo (Rm), Musical Instrument digital Interface (Mid, Rmi), Powerpoint (Ppt), Windows Bitmap (Bmp), CALS Raster (Cal), Lead Compression (Cmp), Encapsulated Postscript (Eps), Kodak Flashpix (Fpx), Winfax (Fxs), IOCA (Ica), Jpeg (Jpg, Jpeg, Jpe), MacPaint (Mac), Microsoft Paint (Msp), Adobe Photoshop (Psd), Macintosh Pict (Pct), Sun Raster (Ras), Zsoft Pcx (Pcx), Portable Network Graphics (Png), TARGA (Tga), Non-LZW TIFF (Tif, Tiff), Word Perfect Image (Wpg), Windows Meta File (Wmf), e-Parcel Comic (Ecb), Text (Txt), Rich Text Format (Rtf), Adobe Acrobat (Pdf), Microsoft Word (Doc), Excel Spreadsheet (Xls), and Hyper Text Markup (Htm, Html). Moreover, the viewer module 416 may be capable of accessing other viewer modules or manipulation facilitating programs in order to transform the decrypted digital content into usable form.

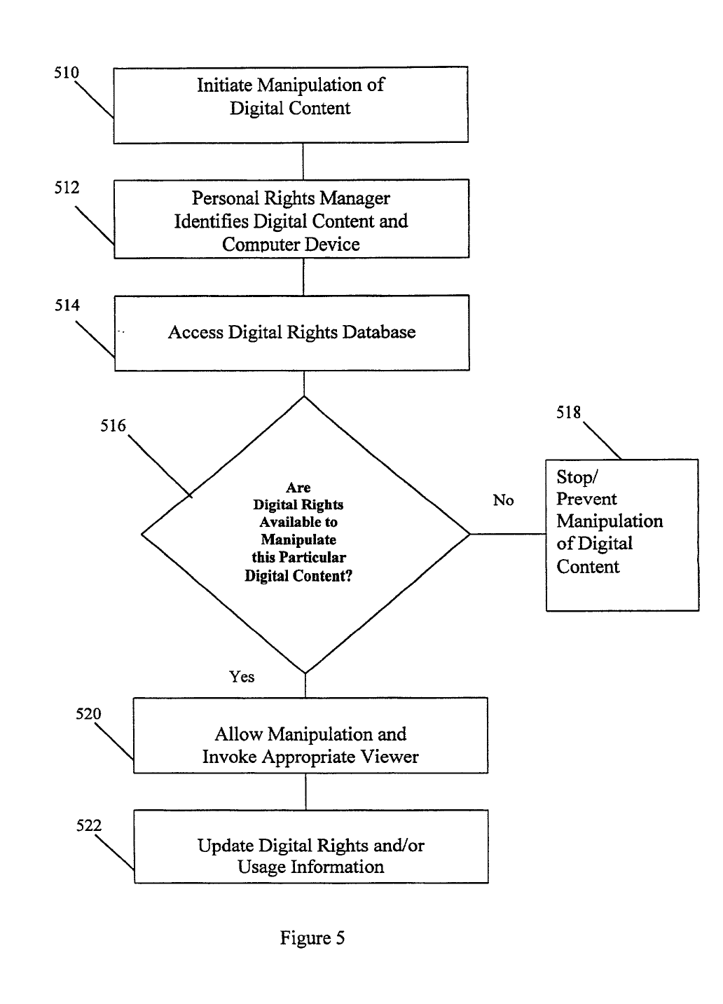

FIG. 5 shows an exemplary process for managing digital rights to manipulate the digital content 320. Generally, in order for the end-user to control the computer 310 to manipulate (e.g., view, run, or modify) the digital content 320, the digital content 320 must be transferred to the computer 310. As discussed above, the digital content 320 may be transferred to the computer 310 using the communication pathway 314 or using some other digital content media (e.g., CD-ROM or floppy disk). Once the digital content 320 is received by the end-user, the digital content may be stored on the computer 310 in, for example, the memory 318.

When the end-user wants to manipulate the digital content 320, the end-user may initiate the manipulation by “launching” the digital content 320 via one of several techniques (step 510). For example, in a windows-based GUI environment, digital content 320 often will have an icon associated with it. For example, the icon may be displayed on the display screen 330 of the end-user's computer system 310. The end-user can “launch” the digital content 320 by “double-clicking” the icon with the mouse or other pointing device 328, thereby starting the process of manipulating the digital content 320. Alternatively, the launch of the digital content 320 can be automated, for example, by another software program or upon startup of the computer 310.

If the digital content 320 is being manipulated on the computer 310 for the first time, an authentication procedure may be employed to verify the authenticity of the digital content 320 and/or the digital rights available to manipulate the digital content 320. Accordingly, before, during or after an end-user initiates manipulation of the digital content 320 (step 510), the personal rights manager module 414 may authenticate the digital content 320. The personal rights manager module 414 may, for example, identify the digital content 320 by locating and decrypting the content ID(s) embedded within the digital content 320 (step 512). Next, the personal rights manager module 414 may, for example, be required to locate the end-user's digital certificate and/or computer device identification information (step 514). Next, the personal rights manager module 414 may, for example, be required to communicate with the global rights manager unit 312 via the communication pathway 314 in order to verify that the particular end-user is authorized to manipulate the particular digital content 320 on the particular computer device 310 (step 516). This authentication procedure also can be done locally, via the local digital rights database 412 or another digital rights database available via some other storage device accessible by the computer 310. Also, digital rights stored locally on the computer 310 or available via some other storage device accessible by the computer 310 can be stored, for example, as an encrypted digital rights database file. This authentication procedure may be required for every attempt to manipulate the digital content 320, the first attempt to manipulate the digital content 320 after it is delivered to the computer device 310, or may never be required, depending on the design and specifications of the content provider.

The personal rights manager module 414 may further access the database of digital rights in order to determine what, if any, digital rights exist to manipulate the digital content 320 (steps 514 and 516). This procedure may entail simply locating the local digital rights database 412, decrypting the local digital rights database 412, and determining the digital rights available to manipulate the digital content 320. Alternatively, this procedure may entail communicating with the global rights manager unit 312 via the communication pathway 314 in order to access the central rights database 340, and determining the digital rights available to manipulate the digital content 320. Again, depending on the design and specifications of the content provider and the level of protection accorded the digital rights of the particular digital content 320 in question, various levels of authorization and determination of digital rights may be required.

Regarding the encrypted data portions of the digital content 320, in one implementation, the key for decrypting the local rights database 412 is the user's public key. An additional key for decrypting the digital content 320 (once the digital rights are determined to exist) may be embedded in the local digital rights database 412.

It should be noted that the personal rights manager module 414 may be designed to execute its functions in a manner transparent to the end-user. As such, the end-user need never realize the extent of the management of digital rights of the digital content 320 that is taking place. The personal rights manager module 414 may be executed through the launch of the digital content 320 (step 510). The personal rights manager module 414 may be a customized software program that enables decrypting and manipulation of the digital content 320. For instance, although the end-user seeks to launch and perhaps perceives a manipulation of the digital content 320, the personal rights manager module 414 is launched before the digital content 320 can be manipulated so as to manage certain digital rights of the digital content 320. Accordingly, the personal rights manager module 414 will allow the digital content 320 to be manipulated only if certain digital rights are granted and/or if certain rules are satisfied. In this manner, the existence, launch and execution of the personal rights manager module 414 may be transparent to the end-user, operating in the background unseen and perhaps undetectable.

Furthermore, the personal rights manager module 414 of the digital content 320 can be a stand-alone software program, or it can be an integrated part of the digital content 320 itself. The personal rights manager module 414 can be designed as a general digital rights management program, or it can be designed to integrate with (or “piggy-back” onto) an independent software vendor's (ISV) existing viewer/manipulation software.

The personal rights manager module 414 determines whether the digital content 320 is permitted to be manipulated (step 516). This determination can take any of several forms. Preferably, the personal rights manager module 514 checks to see if rules specified by the local digital rights database 512 and/or the central digital rights database 340 are satisfied (e.g., if computer device 310 is the same computer device to which this particular copy of digital content 320 was originally delivered, or if an allotted usage time duration has expired). In other words, the personal rights manager module 414 determines whether digital rights exist to manipulate this particular digital content 320 on this particular computer device 310 in the manner attempted by the end-user. In the configuration shown in FIG. 3, this operation may require the personal rights manager module 414 to use the communication device 324 and the communication pathway 314 to communicate with the global rights manager unit 312.

If no digital rights exist to manipulate the digital content 320 on the computer device 310, the personal rights manager module 414 prevents the attempted manipulation, for example, by preventing the decryption of the digital content 320 and/or the use of the viewer module 416 on at least that particular computer device 310 (step 518).

By contrast, if digital rights exist to manipulate the digital content 320, the personal rights manager module 414 can allow the manipulation of the digital content (step 520). This may entail reading the digital content 320 from the storage memory 318 of the computer device 310, decrypting the encrypted digital content 320, and invoking the viewer module 416 (step 520). As discussed above, the viewer module 416 will transform the raw, decrypted digital content 320 into a manipulable form, so that the end-user can manipulate the digital content 320.

Once the digital content 320 is manipulated, the digital rights and/or the usage information associated with the digital content 320 can be updated (step 522). For the sake of design flexibility and mobility of the computer device 310, the digital rights and or usage information may be updated locally in the local digital rights database 412, and optionally in the central digital rights database 340 at a later time. The digital rights associated with the particular digital content 320 can be automatically adjusted to reflect consumption of the digital rights (e.g., if a limited number of manipulations are defined by the digital rights). For example, a digital right such as a “number of times the particular digital content 320 can be viewed” can be automatically decremented each time the digital content 320 is viewed.

Moreover, usage information can be recorded in order to track usage of the particular digital content 320. Tracking/usage information can include, for example, the identity of the end-user and/or computer device 310 manipulating the digital content 320, how the digital content 320 is manipulated, and the number times the digital content 320 has been manipulated (e.g., by viewing or printing), when the digital content 320 is manipulated (e.g., by time-stamping manipulation events), the stage of life of the digital content 320 (e.g., how much digital rights have been consumed, or if the digital content 320 has been purchased for manipulation or is in “try-before-you-buy” stage), the thread of distribution of the digital content 320 (e.g., history of identities of computer devices that manipulated and/or forwarded the digital content 320), current locations of the digital content 320 and which computer devices currently possess the digital content 320, the remaining digital rights of individual copies of the digital content, which portions (e.g., chapters of a digital book or minutes of a digital movie) of the digital content 320 have been manipulated and purchase histories of digital rights associated with a particular copy of digital content 320.

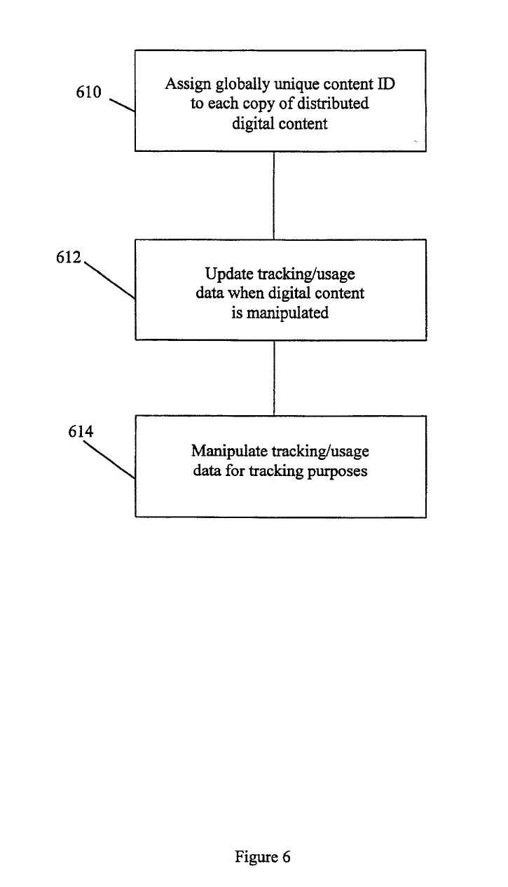

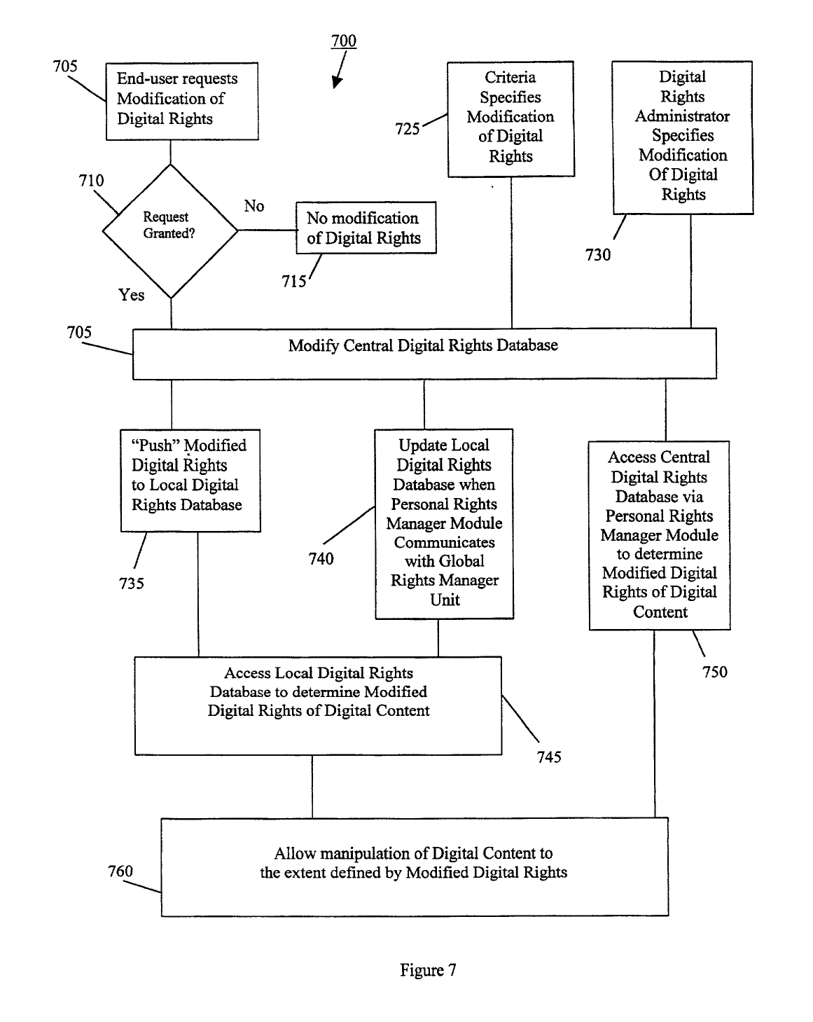

Accordingly, the updated central digital rights database 340 can track the number of computer devices 310 at which the digital content 320 is located, and identify any unauthorized copies and/or uses of the digital content 320. Updating the central digital rights database 340 further allows for the tracking of, inter alia, who is installing the digital content 320 (e.g., via digital certificate information) and when the digital content 320 is manipulated. The tracking capabilities of the system related to the usage/manipulation data and the modification capabilities of the system related to the digital rights are discussed in more detail below with reference to FIGS. 6 and 7, respectively.

In summary, the digital content 320 remains encrypted until the personal rights manager module 414 determines that digital rights exist to manipulate the digital content 320. Furthermore, the local digital rights database 412 remains encrypted until the personal rights manager module 414 requires access to it. Hence, the digital content 320 remains secure from unauthorized duplication, installation, distribution, and other manipulations.

In this manner, digital content 320 can be installed and executed on a computer device 310 while the digital rights for that digital content 320 can be dynamically maintained, enforced and tracked after the delivery of the digital content 320 to the end-user.

As noted above, the system for dynamically managing digital rights of digital content may be further capable of tracking the usage and location of the digital content 320 for the lifetime of the digital content 320. In one implementation, the global rights manager unit 312 may be capable of tracking individual copies of digital content 320, for example, by gathering information about usage/manipulation of the digital content 320. Furthermore, tracking the digital content 320 in this manner allows the global rights manager unit 312 to organize and update (e.g., update digital rights) the individual copies of digital content 320 currently in circulation by individual or group, or globally.

Referring to FIG. 6, each copy of digital content 320 is assigned a globally unique ID before it is distributed (step 610). Additionally, other identifiers may be used to identify when, where, and how a particular copy of digital content 320 was originally distributed. Moreover, a list of original digital rights may be kept as a record that accompanies the digital content 320. As discussed above with respect to FIG. 4, these content IDs can be embedded in the ID portion of the encrypted digital content 320 and remain with the digital content 320 throughout its lifetime. These content IDs allow the system to identify and track the digital content 320 for the duration of its lifetime. Moreover, in the case of forwarding of the digital content (e.g., in a super-distribution method), a new identifier can be stored with the digital content 320 that essentially maps the thread of distribution of the digital content 320. In other words, all of the locations and identities of the computer devices 310 may be recorded, along with information regarding the chain of senders-recipients of the digital content 320 for the entire lifetime of the digital content.

Each time a particular copy of digital content 320 is manipulated, a database of tracking/usage information may be updated (step 612). This database of tracking/usage information may be maintained at least at the computer device 310 in, for example, the digital rights database 412. Additionally, a separate database of tracking/usage information may be maintained at, for example, the global rights manager unit 312. These databases (local and global) of usage/tracking information can be maintained separately and synchronized periodically. The usage/tracking information can include the usage/manipulation information discussed above with respect to FIG. 5, and various other data related to the digital content 320, its usage, its location, its history, and/or its digital rights history. As discussed above with respect to FIG. 5, the digital rights in the local digital rights database 412 and/or the central digital rights database 340 may be updated after each manipulation of the digital content 320. Accordingly, a comprehensive record of the present state and past history of the digital content 320 may be kept in a database either remote from the digital content 320, accompanying the digital content 320, or both.

In order to gather the tracking/usage data that is updated in real-time only at the computer device 310 location (e.g., in the local digital rights database 412 or another file on the computer device 310), the global rights manager unit 312 may be able to poll the computer devices 310 on which digital content 320 is located, or the personal rights manager module 414 of the digital content 320 may be able to “push” the tracking/usage information to the global rights manager unit 312 periodically. Storing the tracking/usage data locally facilitates greater collection of such data, as a communication link between the computer device 310 and the global rights manager unit 312 may not be necessary each time the digital content 320 is manipulated. Thereafter, the tracking/usage information can be transferred to the global rights manager unit 312 when the local digital rights database 412 and the central digital rights database 340 are synchronized (e.g., when a communication link exists between the computer device 310 and the global rights manager unit 312 via the communication pathway 314).

Alternatively, the personal rights manager module 414 can require the computer device 310 to access/update the central digital rights database 340 each time digital content 320 is manipulated in order to update the usage information that may be tracked at the central digital rights database 340. Also, the usage information can be tracked using various other methods.

The global rights manager unit 312, or some other element of the system, such as the customer relationship management unit 334, can use the tracking/usage information for limitless purposes (step 614). Indeed, the global rights manager unit 312 can manipulate and arrange the collected tracking/usage information (stored, for example, in the central digital rights database 340) to allow an administrator to view various statistics and other information about the digital content 320. For example, an administrator can view tracking/usage information about a particular copy of digital content 320, all copies of a particular type/version of digital content 320, all copies of all digital content 320 currently in existence, particular end-user's in possession of the digital content 320, and particular types of computer devices 310 hosting the digital content 320, particular segments (defined, for example, by the administrator) of the digital content holding population. Moreover, particular types of tracking/usage information can be analyzed, such as the number of times the digital content 320 was printed, viewed, copied, or heard, the number of times the digital content has been forwarded, and what pages of text or portions of video were viewed. The global rights manager unit 312 can allow the administrator to access, search, arrange, and analyze all of the tracking/usage information via, for example, the input/output interface 342.

The capability to mine/gather the data associated with the digital content 320 for tracking purposes allows digital content providers and others (e.g., the operators of the customer relationship management unit 334) to track how/when and by whom the digital content 320 is manipulated. Furthermore, it allows administrators of the digital rights to monitor and track digital rights consumption. Moreover, it allows the digital content 320 to be tracked with respect to super-distribution threads (i.e., how many times and by/to whom the digital content 320 is forwarded), and to maintain a map of the present and past locations of all copies of the digital content 320. As such, a complete record of the whereabouts and usage of the digital content 320 and the respective digital rights of those copies of the digital content 320 can be maintained.

Tracking usage of the digital content 320 in this manner allows digital content developers, distributors and administrators to manage the digital rights effectively and dynamically. Furthermore, this usage information can be accessed and used by digital content developers or the customer relationship management unit 334 for future marketing and development purposes.

As discussed above, the system for controlling and managing digital assets may be further capable of modifying the digital rights to manipulate the digital content 320. The local digital rights database 412 can be updated through periodic communication with, e.g., the global rights manager 112 via the communication pathway 314. Accordingly, an administrator (e.g., network administrator, digital content developer, etc.) can modify the digital rights of the digital content 320 after the digital content is delivered to the computer device 310.

Furthermore, digital rights defined in the local digital rights database 412 (stored in the storage memory 318) can be updated and/or revoked periodically by, for instance, “pushing” data from the central digital rights database 340 to the computer device 310. This particular method of “pushing” data requires, of course, some sort of communication between the central rights database 340 and the computer device 310, such as, for example, the communication pathway 314. In the event that the computer device 310 and the global rights manager unit 312 are not in communication with each other for extended periods of time (e.g., if the computer device is isolated from any communication whatsoever, as a stand-alone machine), then the rights defined in the local digital rights database 412 control the rights to manipulate the digital content 320. The global rights manager 112 may be able to sense when the computer device 310 is online (e.g., in communication with the communication pathway 314), and “push” the data at that time. As such, when the end-user “logs onto” the communication pathway 314, this event will drive either the global rights manager 112 or the local digital rights database 412 to communicate with each other. Accordingly, the digital rights stored in, for example, the local digital rights database 412 and the central digital rights database 340 may be updated and synchronized, the clocks of the computer device 310 and the server control unit 138 may be synchronized (or offsets calculated), and the databases of tracking/usage information at, for example, the computer device 310 and the global rights manager unit 312 can be synchronized.

FIG. 7 illustrates a process 700 for implementing the modification of the digital rights. Modifications to the digital rights may include, for example updating, expanding, revoking, increasing, and decreasing all or part of the digital rights. Furthermore, while several methods of modifying digital rights are shown in FIG. 7, various other methods and reasons for modifying the digital rights are encompassed by this description of the process 700.

One manner of modifying the digital rights commences when the end-user requests modification of the digital rights (step 705). For example, if the end-user wishes to have more digital rights to manipulate the digital content 320, the end-user may communicate with the global rights manager unit 312 or the payment processing unit 336 to request the modification of the digital rights (step 705). Human intervention or automated procedures at the global rights manager unit 312 or the payment processing unit 336 may determine whether the end-user's request should be granted (step 710). If the request is denied, then the requested modification of digital rights will not take place (step 715), and a message denying the modification of digital rights may be sent to the end-user. If the request is granted, then the global rights manager unit 312 may modify the central digital rights database 340 (step 720), and, for example, the payment processing unit 336 may accept electronic payment for the additional rights. Additionally, step 705 may be used, for example, when an end-user first acquires the digital content 320 and is prompted by the personal rights manager module 414 to contact the payment processing unit 336 to purchase digital rights before any manipulation of the digital content 320 is allowed.

Another manner of modifying the digital rights commences when criteria requires modification of the digital rights (step 705). For example, if digital rights to manipulate the digital content 320 are allowed for a certain period of time (e.g., “try-before-you-buy” or for as long as periodic payments are made), and that time expires, the digital rights may, for example, be revoked. Further, if illegal manipulation is attempted and/or detected, the digital rights may be revoked. Moreover, if additional digital rights are periodically given out, then the digital rights may be modified to reflect additions (e.g., extensions of time, or new rights). The global rights manager unit 312 may modify the central digital rights database 340 (step 720) to reflect these criteria-driven modifications to the digital rights.

Another manner of modifying the digital rights commences when, for example, an administrator of the digital rights wishes to make modifications (step 730). For example, if the administrator wishes to revoke digital rights of certain end-users, the administrator may modify the digital rights using a software interface that allows the administrator to modify the digital rights in the central digital rights database 340. For various reasons, the administrator may have a need to manually modify the digital rights. For example, if an end-user contacts the administrator because of a problem, the administrator may need to troubleshoot the problem and override some digital right restrictions. Alternatively, the administrator may need to modify the digital rights for a particular copy of digital content 320 for upgrade purposes, demo purposes, or revocation purposes (e.g., if attempts to illegally manipulate the digital content 320 are detected).

Additionally, all of steps 705, 725 and 730 may be implemented after the delivery of the digital content 320 to the end-user. Further, all of steps 705, 725 and 730 may be implemented with varying degrees of granularity with respect to individual copies of digital content in existence. For example, if the digital rights administrator wants to modify digital rights for a particular copy, all copies (e.g., globally), or particularly-defined segments of end-users holding copies of the digital content 320, then the digital rights can be modified on those bases.

Once the digital rights in the central digital rights database 340 have been modified, the global rights manager unit 312 may attempt to “push” the modified digital rights data to the local digital rights database 412 (step 535). This may involve determining whether the computer device 310 is in connected (e.g., “online”) with the communication pathway 314. Otherwise, the global rights manager unit 312 may simply wait until it senses that the computer device 310 is connected with the communication pathway 314. When the computer device 310 is connected to the communication pathway 314, then the global rights manager unit 312 may send the data to synchronize the central digital rights database 340 with the local digital rights database 412.

Alternatively, the local digital rights database 412 may be updated/synchronized when the personal rights manager module 414 contacts the global rights manager unit 312 (step 740), which may be scheduled periodically. At that time, the global rights manager unit 312 may synchronize the local digital rights database 412 with the central digital rights database 340, thereby modifying one or both of the digital rights databases 340, 412 to correspond with the other.

In another implementation, prior to steps 735 and 740, step 720 may be skipped altogether, and the digital rights of the local digital rights database 412 may be modified directly by the global rights manager unit 312, instead of first modifying the central digital rights database 340.

Once the modifications to the digital rights have been made and the digital rights databases 340, 412 have been updated, the updated digital rights will determine how/when/by whom the digital content 320 may be manipulated. When the end-user attempts to manipulate the digital content 320, the personal rights manager module 414 may access the local digital rights database 412 to determine the digital rights of the digital content 320 (step 745), as discussed above. Alternatively, if the local digital rights database 412 does not exist, then the personal rights manager module 414 may simply contact the global rights manager unit 312 each time the digital content 320 is attempted to be manipulated (step 750), to determine the digital rights (and any modifications) to manipulate the digital content 320. Regardless, the digital rights as modified will determine the allowable manipulation of the digital content 320, and the personal rights manager module will allow manipulation of the digital content 320 to the extent defined by the modified digital rights (step 760).

In another implementation, the end-user may receive a password or code to enter into a GUI that enables modification of digital rights without ever having to connect the computer device 310 with the communication pathway 314. For example, the end-user may receive the password over a telephone, and enter the password into a GUI that enables the addition/extension of digital rights to manipulate the digital content 320. This would enable the computer device 310 to remain a stand-alone device and still allow the modification of digital rights. Of course, it may be necessary to include software routines in the personal rights manager module 414 to interface with the end-user in the manner described above.

Furthermore, when any changes occur, such as, for example, a change in the digital rights (e.g., revocation or addition of rights) at the central side (e.g., global rights manager unit 312) or local side (e.g., personal rights manager module 414), the global rights manager unit 312 may automatically attempt to “push” the data (corresponding tot the change in the digital rights) to the computer device 310, or the computer device 310 may be required to “dial-in” to the global rights manager unit 312 to download or upload the data. This type of event-driven synchronization between the local digital rights database 412 and the central digital rights database 340 can be required for all events (e.g., digital content manipulation event or digital right modification event), or merely for some events.

Additionally, the system for dynamically managing digital rights may include a messenger unit as part of the global rights manager unit 312, or as a separate unit capable of communicating with the devices of the system via the communication pathway 314. Alternatively, this messenger unit may be implemented in software included with the digital content 320, such that, for example, the messages are generated locally and announced to the end-user regardless of whether the computer device 310 is connected to the communication pathway 314.

This messenger unit may be capable of sending messages to particular holders (end-users) of particular copies of digital content 320. The targeted recipients can be grouped individually, by segments defined by the global rights manager unit (e.g., all digital content 320 distributed since a certain date), by network, or globally. Also, targets could be defined based on certain behavior (e.g., depending on usage information), particular thread maps in a super-distribution scenario, or life stage of the digital content (e.g., pre- or post-purchase of digital content). The messages generated by the messenger unit could include update and modification announcements, pricing schedules for various additional digital rights, and related messages. Furthermore, the messages could alert the end-user that certain digital rights are about to expire, running low, or exhausted. These messages could be generated periodically by the messenger unit, or could be generated on an event-driven basis. For example, if an end-user has manipulated the digital content 320 to within 5 manipulations of an allotted number of manipulations, the messenger unit could alert the end-user that only 5 more opportunities to manipulate the digital content 320 remain, and possibly suggest methods of extending the digital rights (e.g., purchasing more rights by communicating with the payment processing unit 336). In another example, if the rights have expired and the end-user attempts to manipulate the digital content 320, the messenger unit could alert the end-user that the rights have expired and suggest options to acquire more rights.

Additionally, for greater security and added tracking precision, when the global rights manager unit 312 and the computer device 310 (i.e., the personal rights manager module 414) are in communication with each other, a clock of computer device 310 may be synchronized with a clock of the global rights manager unit 312. Alternatively, an offset between the two clocks may be calculated and stored at the global rights manager unit 312. Accordingly, the tracking and security of the digital content 320 may be made more accurate.

Many of the steps in the exemplary processes shown by FIGS. 4-7 can be rearranged, supplemented with other steps, combined or selectively removed. Other modifications also may be made. For example, digital content can be distributed as a file or on a CD-ROM in the format shown in FIG. 5, without requiring the installation procedure described with respect to FIG. 6.

The systems and techniques described above are applicable to all types of digital content, including software. However, more specialized techniques may be employed with respect to software. These techniques are discussed next.

Digital rights related to installation and execution of software are managed such that, for example, installation of the software is accomplished only if a particular computer system is authorized to install the software, and execution of the software is accomplished only if the computer system is authorized to execute the software. Furthermore, software copied from an installed version of the software does not work properly, since, for example, at least a portion of the software installed on the computer system may be encrypted.

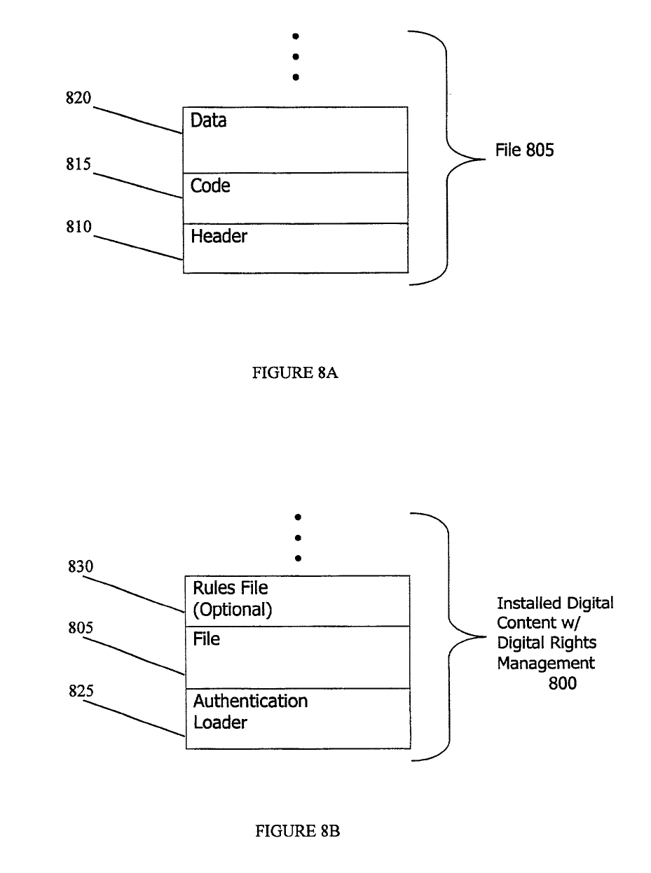

Referring to FIGS. 8A and 8B, software digital content 800 may include an executable binary (EXE) or other machine language file 805. The file 805, as digital content 800, includes a header portion 810 for identifying the file, a code portion 815, and a data portion 820.

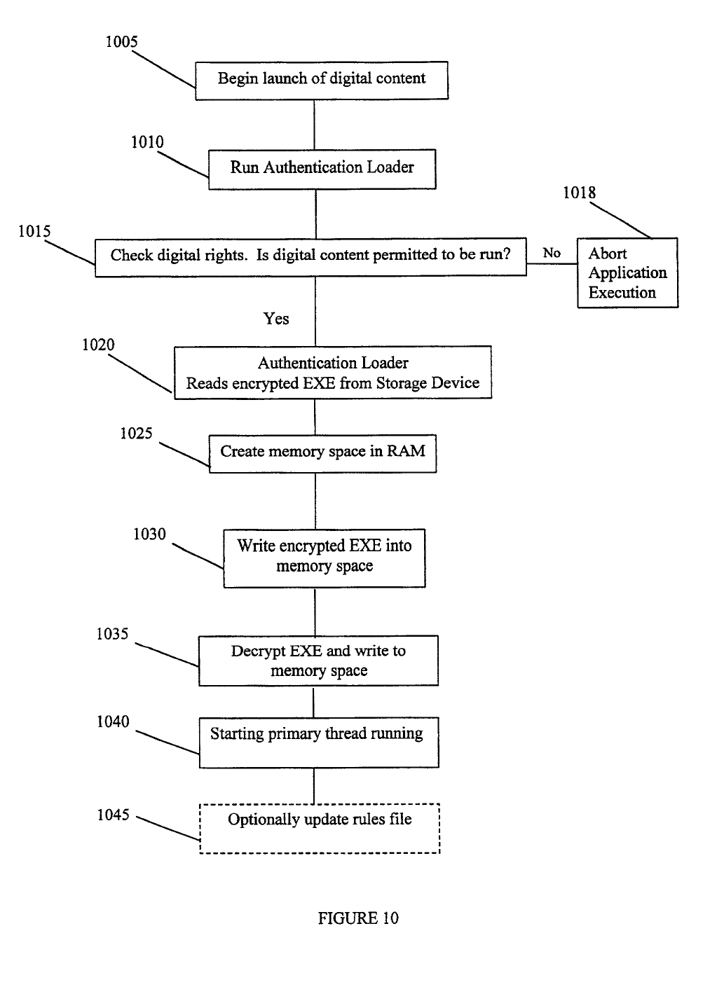

Digital content 800 may be installed on the storage memory 318 and may include an encrypted or unencrypted version of file 805, a customized authentication loader 825, and a rules file 830 (where rules correspond to the rights discussed above). The digital content 800 may be installed or stored on the computer device 310 in the format shown in FIGS. 8A and 8B or in various other formats, such as randomly writing portions of the digital content 800 in noncontiguous areas of the memory storage 318. Furthermore, the relative orientation of the portions of the digital content 800 may differ from that shown by FIG. 8B, and the rules file 830 may be optionally stored remote from the file 805. Indeed, the rules file 830 can be located elsewhere in the storage memory 318, at the central digital rights database 340, or elsewhere. Moreover, the authentication loader 825 may be a separate customized software program that causes the file 805 to run on the computer device 310, as discussed below with respect to FIG. 10. However, for simplification, the exemplary format shown in FIGS. 8A and 8B will be used in this description.

In order to achieve security using the software digital rights management system, at least a portion of the digital content 800 installed on the computer device 310 may be encrypted. For example, either or both of the file 805 and the rules file 830 can be encrypted. Furthermore, each copy of the digital content 800 distributed to end-users may be made uniquely identifiable. One technique for identifying a particular copy of the digital content is to assign a content ID to each particular copy of the digital content, wherein the content ID is globally unique. As such, each particular copy of the digital content can have a unique content ID embedded in it, for instance within the encrypted portion of the digital content 800 (such as discussed above with respect to FIG. 4).

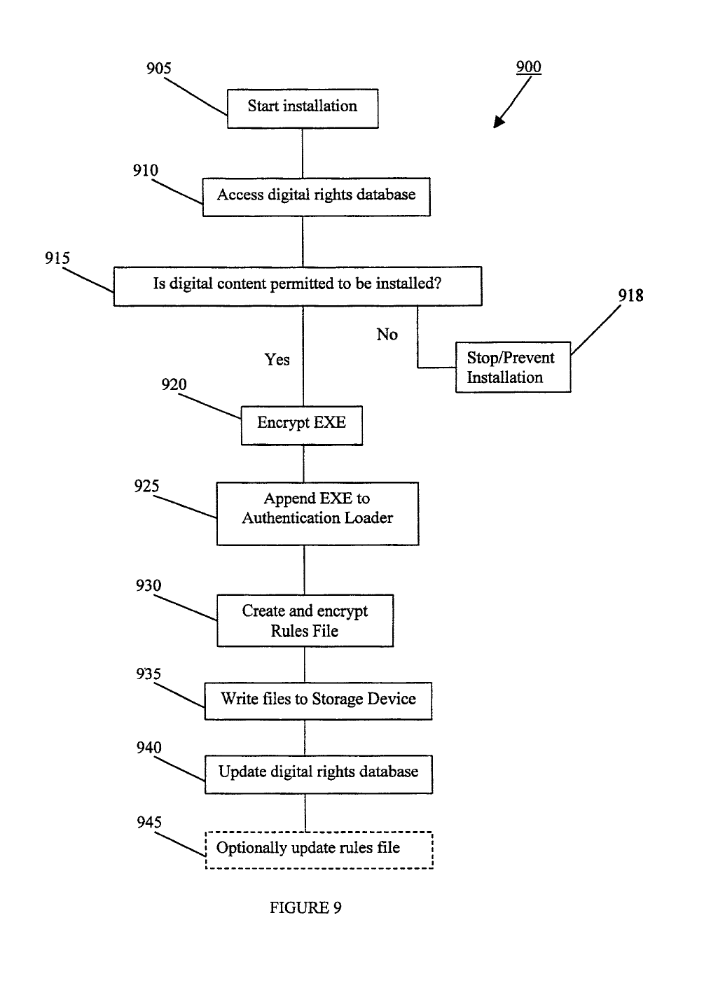

Referring to FIG. 9, the software digital content 800 may be installed according to a procedure 900. Typically, installation is initiated by, for example, manually locating an installation portion of the digital content package and causing the installation portion to execute, or automatically locating and executing the installation portion of the digital content such as upon receipt of the digital content (step 905). It should be noted that the installation portion of the digital content can be a stand-alone software program (i.e., an installer program), or it can be integrated as part of the digital content itself. The installer program can be designed as a general digital rights management installer program, or it can be designed to integrate with (or “piggy-back” onto) an independent software vendor's (ISV) existing installer program. Regardless, once the installation portion is initiated, the process shown in FIG. 9 can continue.

Next, the local digital rights database 412 or the central rights database 340 is accessed (step 910) to determine whether the installation of the software digital content is authorized (step 915). This process may be referred to as “authentication” of the digital content. When the central rights database 340 is used, the installer program can initiate contact with the central rights database 340 via the communication device 324 of the computer device 310 and the communication pathway 314. After contact is made, the installer program, in concert with the digital rights database 340, “authenticates” the digital content (e.g., determines whether installation of the digital content on the computer device 10 is authorized). This authentication procedure also can be done locally, using the local separate digital rights database 412.

In an exemplary authentication procedure, a globally unique content ID for the software digital content is checked for the digital rights assigned to the particular digital content being installed. Additionally, a digital certificate can be used to identify, for instance, the end-user and the computer device 310 on which the digital content is being installed. The authentication procedure may verify whether the digital content is an authorized copy. The authentication procedure also can be used to verify whether the installer program is an authorized copy. Furthermore, the authentication procedure can verify, for example, whether the digital content is allowed to be installed on the particular computer, whether the digital content is allowed to be installed at all (due to, for example, the expiration of an allotted number of installations), and whether the digital content is being installed from an authorized backup copy of the digital content.

If no authorization exists to install the digital content on the computer device 310, the installer program will stop, which prevents installation and execution of the digital content on at least that particular computer device 310 (step 918).

By contrast, if authorization exists, the installer program encrypts at least a portion of the file 805 to be installed (step 920). Alternatively, the file 805 can be encrypted before commencing the installation process shown in FIG. 9, such as, for example, when the digital content is prepared by the content provider for distribution.

In the example discussed above with respect to FIG. 8, the file 805 includes a header portion 810, a code portion 815 and a data portion 820. Encryption generally is provided for at least one of the code portion 815 and the data portion 820. However, both the code portion 502 and the data portion 820 may be encrypted, the entire file 805 may be encrypted, or none of the file 805 may be encrypted. The strength of the encryption algorithm used to encrypt the file 805 can vary depending on the circumstances. In one implementation, it is 256-bit encryption.

An authentication loader may be appended to the file 805 or otherwise related to the file 805 (step 925). When the authentication loader is not appended to the file as installed on the computer 310, the authentication loader can be written to the storage memory 318 in a location separate from the file while maintaining a relationship (e.g., a mapping to) the encrypted file in the storage memory 318.

A rules file having digital rights management properties may be created and/or encrypted (step 930). The rules file can be a unique rules file created during the installation process. For instance, the identity of the computer 310, the digital certificate and other identifying characteristics may be integrated in the definition of the digital rights of the software. Such identifying characteristics can be used, for example, to authorize the execution of the installed software on only that particular computer 310. In this manner, an unauthorized copy of the installed software will not work on any other computer. Alternatively, a less restrictive rules file can be created by the digital content developer for use on a plurality of computers.

The rules file can be written using extensible markup language (XML) to define digital rights for the installed software. Of course, various other formats can be used for the rules file. The rules file may reside in the computer 310 in encrypted format. The strength of the encryption algorithm used to encrypt the rules file can vary depending on the circumstances, but is 256-bit encryption in many implementations.

The rules file can be updated through periodic communication with the central rights database through the communication pathway 314. Accordingly, an administrator (e.g., a network administrator or a digital content developer) can modify the digital rights of the software after the software is installed on the computer 310.

The digital content file then is written to a storage device of the computer 310, such as the storage memory 318 (step 935). Preferably, at least the authentication loader is appended to the file and together they are written to a location in storage memory 318. Additionally, the rules file containing digital rights is written to the storage memory 318. The rules file can be appended to the digital content file or written to a storage memory location in the storage memory 318 that is non-contiguous with the memory storage location of the digital content. Moreover, the rules file can be hidden in memory storage 318 such that an end-user cannot find it via normal file search methods (e.g., Windows Explorer).

Finally, the central digital rights database 340 may be updated, for example, to track how many times a particular copy of the digital content is installed (step 940). Additionally, the digital rights can be automatically updated each time the digital rights database 340 is accessed by the installer program. For example, a digital right such as a “number of times the particular digital content can be installed” can be automatically decremented each time the digital content is installed and the digital rights database 340 is accessed. Moreover, the updated digital rights database 340 can track the number of computers on which the digital content is installed, and identify any unauthorized uses of the digital content. Updating the digital rights database 340 further allows for the tracking of, among other information, who is installing the digital content (e.g., using digital certificate information) and when the digital content is installed. This information can be accessed and used by digital content developers for future marketing and development purposes.

It should be noted that once the digital content is installed, or anytime after the digital content is authenticated in the exemplary process of FIG. 9, the rules file (i.e., digital rights) can be updated to reflect the latest manipulation of the digital content (step 945). Furthermore, digital rights defined in the rules file (stored in the storage memory 318) can be updated and/or revoked periodically by, for instance, “pushing” data from the central rights database 340 to the computer device 310.

Additionally, information regarding the usage (e.g., number of times installed, run or modified) of the digital content can be stored in the rules file, a separate usage data file, the local digital rights database 412, or at the digital rights database 340. Usage information stored in the rules file or another file on the computer 310 can be accessed by the control rights database 340 or periodically “pushed” to the central rights database 340. Also, the usage information can be tracked using various other methods.

Although not shown, the exemplary process shown in FIG. 9 can additionally include using a setup program to allow further customization of digital rights for the digital content upon installation (e.g., by including or excluding certain portions of the digital content in the installation). It is not necessary to use a setup program to install the digital content on the computer 310, but the setup program may be useful in allowing the installer or the end-user to configure the digital content or the computer 310.

Once the digital content is installed on the computer 310, for example, by the exemplary process illustrated in FIG. 9, it generally is ready for manipulation. The end-user may begin to run or “launch” the software program via one of several techniques for starting software applications. For example, in a windows-based GUI environment, a software program often will have an associated icon. For example, the icon may be displayed on the display screen 330 of the end-user's computer system 310. The end-user can “launch” the software by “double-clicking” the icon with the mouse or other pointing device 328, thereby starting the process of loading and running the software.

Generally, when a software launching process is initiated (e.g., by an end-user, automatically, or by another software program), the software to be launched is first read from a memory storage device, for example, a hard drive or CD-ROM. Upon launch, available memory space for the software code is located and reserved in the computer's RAM. Next, the software code is written into the memory space in RAM, a pointer is set to the beginning of the software code in RAM, and the CPU begins reading the software code instructions to begin executing the software instructions. This process may be referred to as starting a primary thread running. As soon as the first software code instructions are executed, the data portion of the EXE immediately begins to change because the software code uses and modifies the data in the data portion.

Referring to FIG. 10, an end-user may initiate the launch of the digital content in a manner described above (step 1005). Alternatively, the launch of the digital content can be automated, for example, by another software program or upon startup of the computer 310.

The authentication loader is executed through the launch (step 1010). As discussed above with respect to FIG. 9, the authentication loader may be a customized software program that enables loading and execution of the file within the digital content. For instance, although the end-user seeks to launch and perhaps perceives a launch of the file within the digital content, the authentication loader is launched before the file to manage certain digital rights of the digital content. Accordingly, the authentication loader will allow the target file to run only if certain digital rights are granted and/or if certain rules are satisfied. In this manner, the existence, launch and execution of the authentication loader may be transparent to the end-user, operating in the background unseen and perhaps undetectable.

The authentication loader determines whether the digital content is permitted to be run (step 1015). This determination can take any of several forms. For example, the authentication loader may check to see if rules specified by the rules file are satisfied (e.g., if computer 310 is the same computer on which this particular copy of digital content was installed, or if an allotted usage time duration has expired). In other words, the authentication loader determines whether digital rights exist to manipulate this particular digital content on this particular computer 310 in the manner requested. Alternatively, the authentication loader can be designed to access the local digital rights database 412, the control rights database 340, or some other rules file/database to determine whether the requested manipulation of the digital content is permitted. In the configuration shown in FIG. 1, this operation may require the authentication loader to use the communication device 324 and the communication pathway 314 to communicate with the control rights database 340.

As discussed above with respect to FIG. 9, this run-time authentication by authentication loader can range from merely cursory to very thorough, depending on the level of protection accorded the digital rights of the particular digital content in question. If no authorization exists to manipulate the digital content on the computer 310, the authentication loader will prevent the attempted manipulation by, for example, preventing the execution of the target file on the computer 310 (step 1018).

By contrast, if authorization exists, the authentication loader reads the file from the storage memory 318 of the computer 310 (step 1020). This reading generally includes locating the file on the storage memory 318 if the file was not appended to the authentication loader during the installation procedure.

Once the file is read from the storage memory 318, the authentication loader begins loading the file. First, the authentication loader requests that memory space be allocated in RAM 322 to accommodate the file (step 1025). Next, the authentication loader writes the file into the memory space in RAM 322 and sets the computer's pointer to the first address of the memory space containing the file (step 1030). Subsequently, where appropriate, the authentication loader decrypts the encrypted portions of the encrypted file and replaces the encrypted file written into the memory space of RAM 322 with the entirely decrypted version of the file (step 1035). Once the file is decrypted, the authentication loader initiates running of a primary thread (step 1040). In other words, the computer's pointer, pointing at the first memory address of the file in the memory space of RAM 322, begins reading the software code instructions and the CPU 316 executes the instructions.

It should be noted that once the digital content is executed, or any time after the digital content is authenticated in the exemplary process of FIG. 10, the rules file (i.e., digital rights) can be updated to reflect the latest manipulation of the digital content (step 1045).

The execution of the software code instructions happens immediately after the encrypted file is decrypted by the authentication loader. Moreover, the decrypted data portion of the file begins to change as soon as the execution of the software code instructions commences. Hence, the file remains secure from unauthorized duplication, installation, distribution, and other manipulations of the digital content.

In this manner, software digital content can be installed and executed on a computer system while the digital rights for that digital content can be maintained and enforced after the delivery of the digital content (e.g., software) to the end-user.

The described systems and techniques may be used to implement a collaboration system in which different collaborators can suggest changes to a digital asset that will be presented to other collaborators but will not actually modify the digital asset. Changes offered by each collaborator are maintained in a change document that is associated with the digital asset. The change document for each collaborator may be viewed by other collaborators, but may not be edited by them. In one implementation, changes offered by different collaborators are presented in association with the original digital asset (typically using a different color, font, or set of descriptive characters, such that changes offered by different collaborators may be readily perceived. As each set of changes is layered upon the original digital asset, an onion-like structure may be formed, with each additional set of changes acting as a layer that encapsulates the original digital asset and any subsequent sets of changes. Each layer may be encrypted with a different encryption key and may be associated with a different set of rights.

Authorized modifications made to a digital asset by a collaborator are recorded along with attribute information (e.g., identifying information for the collaborator, date and location of modification(s), and notes concerning the modification(s)). Information concerning the authorized modifications typically are stored separately from the digital asset to preserve the integrity of the original digital asset. For instance, as noted, changes may be provided and shown using an electronic transparency that corresponds to the digital asset being changed. By contrast, changes to the original digital asset may be recorded individually along with information identifying the particular contents being changed (e.g., using a pointer). In this manner, the entire contents of the digital asset may or may not be duplicated. Rather, particular portions of the digital asset that have been changed may be themselves referenced, as necessary.

Through modification tracking, collaborators are prevented from making transparent or difficult to detect changes to the electronic document. Changes instead remain clearly identifiable to other collaborators, in a manner that appears similar to the change-tracking technologies used in word processing systems. In this manner, digital asset protection techniques are combined with modification tracking technology to prevent unauthorized copying or modification of a digital asset. A collaborator cannot disable or turn off the tracking and, thus, is not able to conceal his/her changes to the digital asset.

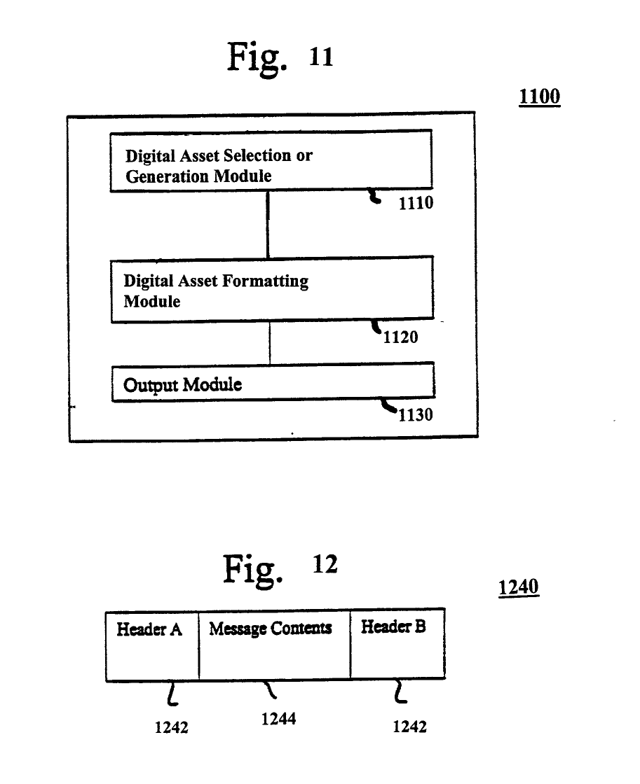

As illustrated by FIG. 11, software 1100 enables the sender of the digital asset to designate whether the digital asset should have modification tracking before sending the digital asset. As shown, software 1100 includes a digital asset selection or generation module 1110, a digital asset formatting module 1120, and an output module 1130.

Digital asset selection or generation module 1110 is used to select or generate digital assets to be sent to one or more intended recipients. Examples of module 1110 include standard or proprietary electronic mail software packages and other electronic delivery systems.

Digital asset formatting module 1120 solicits formatting preferences from a sender and generates formatting information to implement the selections indicated. For instance, an icon, a pull down menu, a default setting, or some other means may be used by a sender to enter formatting preferences. The formatting preferences may include information indicating the desire for secure storage, copy protection, automatic deletion and/or modification tracking, as described above. Digital asset formatting module 1120 may indicate this formatting information through the use of appended electronic headers 1242 preceding or following the digital asset contents 1244, as reflected by item 1240 of FIG. 12, or otherwise through the use of digital information related to the digital asset content being sent. In any case, the formatting information is detected by the recipient and used to invoke the selected protection or tracking function. Output module 1130 is used to send collaboration digital assets that have been output by module 1110 and formatted by module 1120.

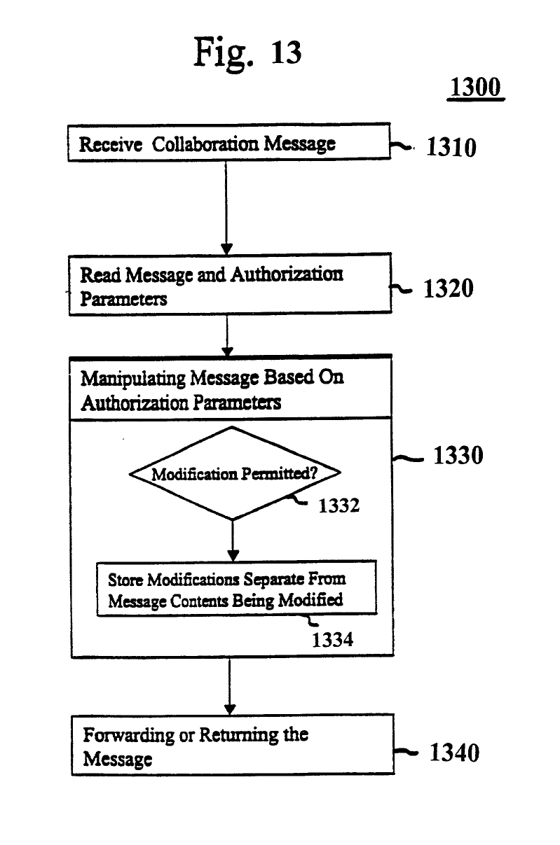

FIG. 13 illustrates an exemplary process 1300 performed by software 1100. Process 1300 includes receiving a digital asset (step 1310), reading the digital asset and authorization parameters (step 1320), manipulating the digital asset based on the authorization parameters (step 1330), and forwarding or returning the digital asset as appropriate (step 1340).

Reading the digital asset (step 1320) generally involves verifying authorization based on formatting information. Furthermore, reading may involve determining limitations on authorization and/or access that have been imposed by the sender of the digital asset, for example, through formatting information and the like. For instance, a determination may be made as to whether the sender has selected to invoke modification tracking, as described above. This information is generally gleaned through the formatting information provided with or included in the digital asset. A receiving system may be configured to poll incoming digital assets for such formatting information.

Manipulating the digital asset based on the perceived authorization parameters (step 1330) generally involves at least two steps: determining whether a proposed modification is permitted (step 1332), and, if appropriate, storing modifications separate from the digital asset contents so as to track the modifications based on the content being modified (step 1334). These steps may be accomplished using a specialized system designed to accommodate limitations on receipt authority. This system, which is referred to as a collaboration viewer, enables authorized recipients to decipher digital asset contents and to make desired and authorized modifications. Changes made to the digital asset using the collaboration viewer are appended to the original digital asset, rather than affecting the original digital asset itself. That is, the changes may be appended to that digital asset along with some attribute identifiers such as the name of the changing recipient and the date of the change. In addition, a pointer may be provided to reflect the location of changes made within the document.

The digital asset then may be sent back to the server from which it came and/or forwarded to the next recipient among a predetermined number of recipients (step 1340). The next recipient, regardless of how the digital asset is received, goes through the same procedure. Ultimately, the digital asset may reach its final destination (e.g., may be returned to the sender) and the final recipient is able to decrypt and view the digital asset with some or all of the changes integrated into the digital asset, or with some or all of the changes being shown on a separate document. Furthermore, the changes within the document may be displayed in conjunction with attributes such as collaborator identity and date of change, and may use different colors, fonts, or surrounding characters to identify particular collaborators.

Although this process is generally described using a ring type network, where the digital asset goes to the users and finally returns to the sender after all the users indicate their changes, it also is possible to use this type of configuration where the document is returned to the server after each individual user makes changes, or where information about the changes are forwarded back to the sender as the changes are made. For instance, multiple users could simultaneously access a single collaboration, or the sender may be apprised of changes made by serial recipients as those changes are being entered.

In the manner described above, a synergistic combination is realized between security and document collaboration. Among other aspects, a document collaboration user may limit the recipient's use of documents by restricting the recipient's ability to forward or copy the electronic document without showing changes made to the document. Although a digital transparency may be used to reflect changes, a character-by-character comparison technique typically is employed to guarantee that changes are stored and viewable without requiring storage of a digital transparency or the like.

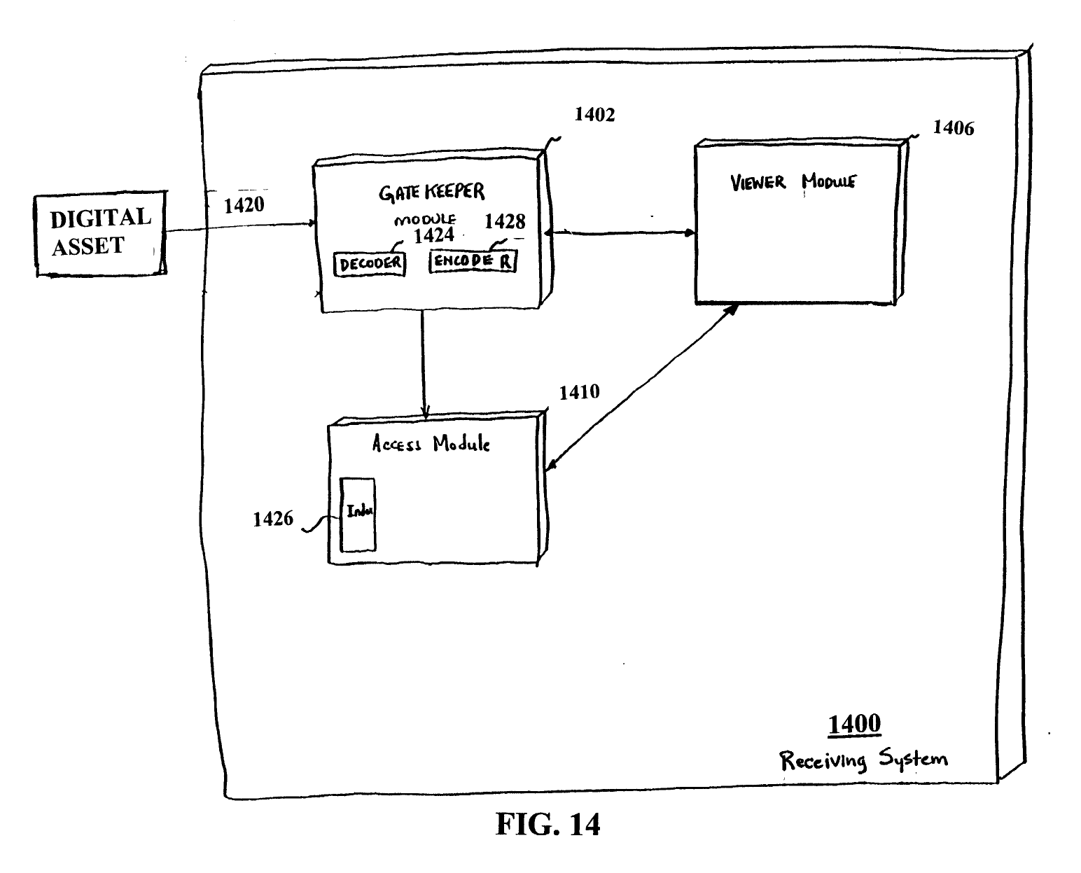

FIG. 14 shows a block diagram of exemplary software components of the software installed on the receiving system 1400. The software components include a gatekeeper module 1402 in communication with a viewer module 1406 and an access module 1410. The gatekeeper module 1402 receives a digital asset 1420. The digital asset 1420 may be received from the network after being sent by the sending system or the server system, or may be obtained from CD-ROM, diskette, or local memory.

To secure the digital asset 1420 during transmission and make efficient use of resources (e.g., network bandwidth, storage, or memory), the digital information representing the digital asset 1420 may be encoded and compressed when received at the receiving system. The gatekeeper module 1402 includes a decoder 1424 capable of decompressing and decoding the digital information to produce clear text. Clear text can be, for example, a stream of bits, a text file, a bitmap, digitized audio, or a digital image, that typically requires further processing to generate the digital asset 1420. It will be appreciated that the decoder 1424 may include a key necessary for obtaining the clear text from the encoded and compressed digital information.

The gatekeeper module 1402 communicates with the access module 1410 to store the digital information corresponding to the digital asset 1420 in memory. The access module 1410 includes an index 1426 for recording the physical storage locations (i.e., addresses) of the digital information in memory.

The viewer module 1406 is an application program that can process the format of the clear text to enable viewing of the digital asset 1420. The viewer module 1406 can provide a viewing capability for a wide variety of formats by including one or more viewer modules and/or viewer applications for each format type. An example of a viewer application that can be included within the viewer module 1406 is a program that displays images stored in a GIF format, which is a graphics file format used for transmitting raster images on the Internet. Some of the viewer modules and viewer applications incorporated within the viewer module 1406 can be commercially-available viewer applications. One such application is Adobe ACROBAT, which converts fully formatted documents from a variety of applications into a Portable Document Format (PDF) that can be viewed on various system platforms. Other commercially-available viewer applications can be a word processing program or a spreadsheet program (e.g., Microsoft WORD and Microsoft EXCEL).

Viewer application programs and viewer modules can be dynamically added to the viewer module 1406. For example, in the instance where the format of the clear text requires a viewer application not currently available on the receiving system, the receiving system can request and download that application from another system, where the application is known to reside, and add that application to the viewer module 1406.

When generating audiovisual output corresponding to the digital asset 1420 on an output device (e.g., a display screen), the viewer module 1406 communicates with the access module 1410 to retrieve the clear text from memory. To secure the clear text while stored in the memory, the gatekeeper module 1402 can encode the clear text using an encoder 1428 and a key associated with the user of the receiving system.

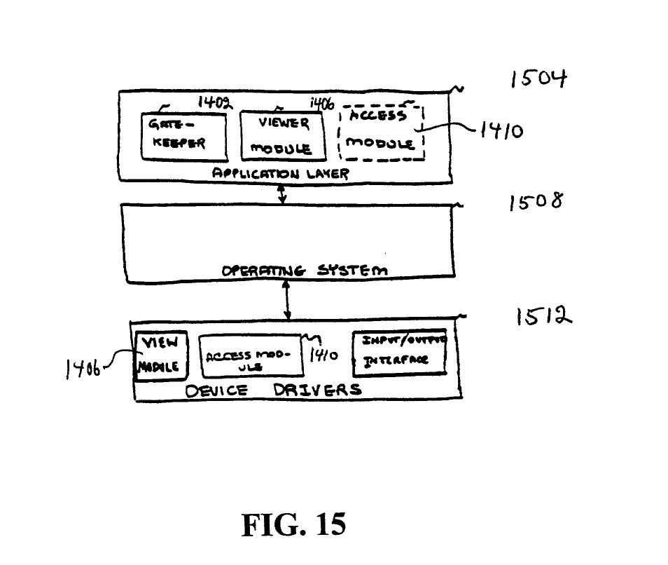

FIG. 15 shows an exemplary organization of the software components within the receiving system. The software organization includes an application layer 1504, an operating system layer 1508, and a device driver layer 1512. The application layer 1504 interfaces with the operating system layer 1508. The operating system layer 1508 includes the software for controlling and using the hardware of the receiving system. Two exemplary operating system procedures include a read operation and a write operation. To control the hardware, the operating system layer 1508 interfaces with the device driver layer 1512. Device drivers 1512 communicate with the hardware to transmit and receive digital information from the hardware.

In the implementation shown in FIG. 15, the gatekeeper module 1402 is an application program at the application layer 1504. The viewer module 1406 and the access module 1410 are device drivers that cooperate with the operating system 1508 to communicate directly with an output device and the memory, respectively. In another implementation, the view module 1406 and/or the access module 1410 can be application programs at the application layer 1504 that communicate with the hardware through an input/output interface at the device driver 1512.

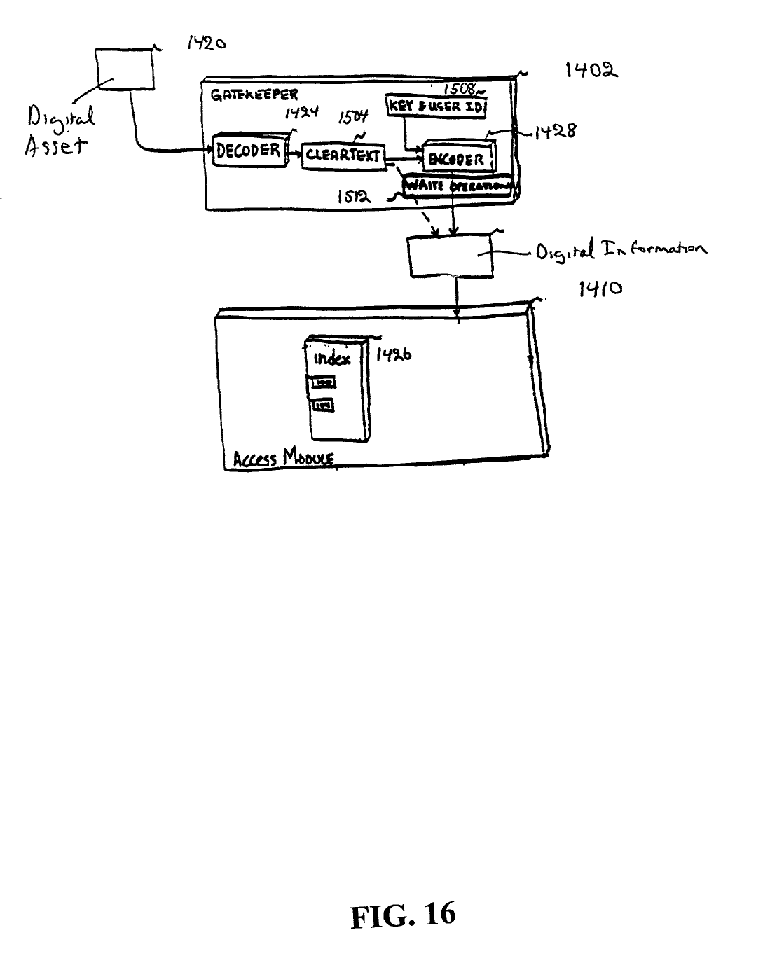

FIG. 16 shows exemplary processes by which the client software on the receiving system protectively stores the received digital asset 1420. In the event that the digital asset 1420 is compressed and encoded, the decoder 1424 decompresses and decodes the digital information of the digital asset 1420, as appropriate, to produce clear text 1504. If stored in memory as clear text 1504, the digital asset 1420 may be intelligible to any process with access to the physical storage locations of the clear text 1504. As described above, to reduce the likelihood of such access, the gatekeeper module 1402 may provide secure storage of the digital information by encoding the clear text 1504, randomizing the physical storage locations of the digital information in memory, or both, or by other methods.

To encode the clear text 1504, the encoder 1428 uses an encryption algorithm that may involve a key 1508 associated with the user of the receiving system. The gatekeeper module 1402 generates the key 1508 when the user successfully logs onto the receiving system. Accordingly, any process that accesses the physical storage locations of the encoded information cannot generate the digital asset 1420 without the key 1508. Although the digital information stored at those physical storage locations may be accessed, copied, and disseminated, the encoding of the digital information secures the digital asset 1420.

The gatekeeper module 1402 then performs a write operation 1512 through the operating system and forwards the digital information to the access module 1410. The access module 1410 performs a write operation to write the digital information into the memory, storing the digital information at contiguous address locations of the memory or at randomly generated address locations.

When the access module 1410 distributes the digital information at randomly determined address locations of the memory, only a process that obtains every portion of the digital information pertaining to the digital asset 1420 can reconstruct the complete digital asset 1420. The index 1426 of the access module 1410 maintains pointers to the storage locations of each portion of the digital information. An authenticated process can access the index 1426 to obtain every portion and properly reassemble the digital asset 1420 for output. To conceal the physical storage locations from unauthorized access, the pointers themselves can be encoded. By encoding the pointers, any process that accesses the index 1426 without decoding capabilities is still unable to decipher the storage locations at which to find the digital information.

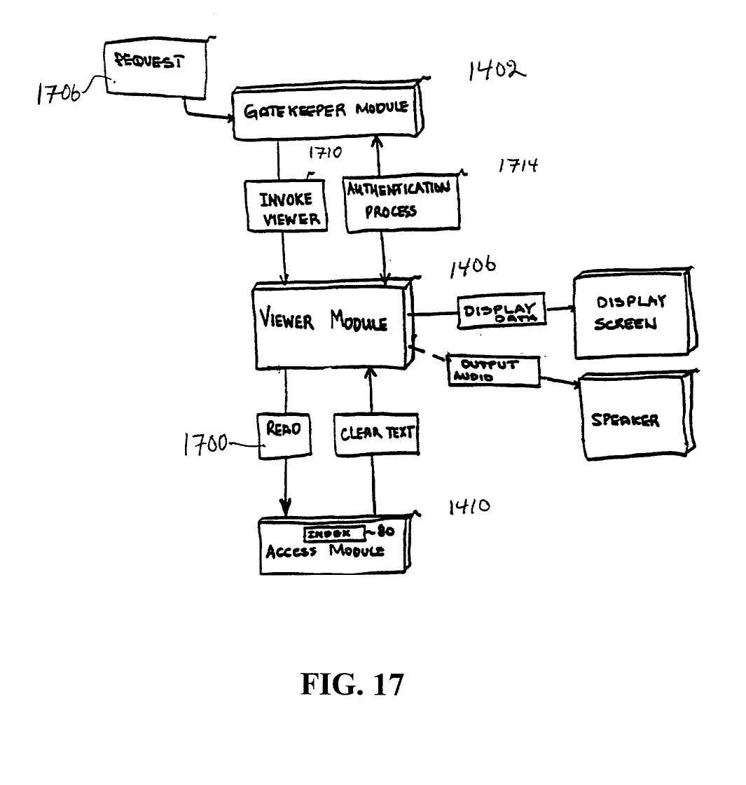

FIG. 17 shows an exemplary process by which the digital asset 1420 is reconstructed. When the receiving system makes a request 1706 to obtain the digital asset 1420, the gatekeeper module 1402 verifies the validity of the request 1706 and the authenticity of the requesting user. Upon verifying the request 1706 and the user, the gatekeeper module 1402 determines the appropriate viewer application program for outputting the digital asset 1420. The gatekeeper module 1402 selects the appropriate viewer application according to the format of the digital information. In the event that more than one viewer application program within the viewer module 1406 can be used to output the digital asset 1420, the gatekeeper module 1402 chooses one of the viewer applications based upon a predetermined priority ranking among the viewer application programs or a selection by the requesting party. The gatekeeper module 1402 invokes the viewer module 1406 to start the appropriate viewer application program (step 1710).

Upon invoking the viewer module 1406, the gatekeeper module 1402 and the viewer module 1406 can engage in an authentication process to ensure that the viewer application program is authorized to output the digital asset 1420 (step 1714). The gatekeeper module 1402 sends encoded, randomly generated text to the viewer module 1406. Only an authentic viewer module 1406 can return the correct clear text corresponding the encoded text. An unauthorized process running on the receiving system in an attempt to supplant the viewer module 1406 and capture the digital asset 1420 cannot generate the digital asset 1420 without first passing this authentication process.

If the gatekeeper module 1402 receives clear text from the viewer module 1406 that correctly corresponds to the encoded text, the gatekeeper module 1402 generates a session key and a process identification. The gatekeeper module 1402 sends the session key to the viewer module 1406, and the viewer module 1406 uses the session key in all subsequent communications with the gatekeeper module 1402. For all such communications, the gatekeeper module 1402 verifies the session key and the process identification.

Upon authenticating the viewer module 1406, the gatekeeper module 1402 subsequently invokes the access module 1410, providing the access module 1410 with the necessary information about the selected viewer application program. The viewer module 1406 then is able to access the digital asset 1420, although no other processes are able to do so.

When the user of the receiving system wants to output the digital asset 1420, the viewer module 1406 executes read operations 1700 of the operating system, and the operating system communicates with the access module 1410. In one implementation, the read operations 1700 are designed to decode the encoded digital information after reading the encoded digital information from the memory. Another viewer application program that reads the memory using standard read operations may access correct storage locations in the memory, obtaining only encoded information.

In response to the read operations, the access module 1410 obtains and passes the digital information to the viewer module 1406. The viewer module 1406 then generates the digital asset 1420 from the digital information and outputs the digital asset 1420 at the receiving system. This output can be a display on the display screen, sound at the speaker, and/or other output. To prevent the receiving system user from producing or distributing unauthorized copies of the digital asset 1420, the viewer module 1406 provides minimal functionality to the receiving system user while displaying the digital asset 1420 (where displaying may include producing sound). The capabilities typically available in standard viewer applications may include saving the digital asset in a file, forwarding the digital asset to another device (e.g., a fax machine or a printer) or computer system, modifying the displayed digital asset, or capturing a portion of the displayed digital asset into a buffer (i.e., cut-and-paste). For example, to withhold printing capabilities from the user, the viewer module 1406 can redefine the available or activated keys on the keyboard so that none of the keys provide “print-screen” functionality. Consequently, the receiving system user is limited to viewing (or listening to) the digital asset and terminating such viewing.

In another implementation, the viewer module 1406 permits the user to send the digital asset 1420 to the printer but not to print to a file. Because the viewer module 1406 prevents the user from modifying the digital asset 1420, the hard-copy print-out is an exact version of the generated digital asset 1420. Using this feature, system users can exchange documents with an assurance that such documents cannot be electronically modified. The viewer module 1406 can also restrict the number of printed copies to a predetermined limit.

The viewer module 1406 also can operate to prevent other processes running on the receiving system from capturing the digital asset 1420 while the digital asset 1420 is being displayed. Such processes may originate at the receiving system or from a remote system attempting to communicate with the receiving system. To restrict the receiving system user from executing other processes at the receiving system, the viewer module 1406 displays the digital asset on top of all other graphical windows or displays on the display screen. The viewer module 1406 also can maximize the displayed digital asset to fill the display screen, disabling the user from minimizing or decreasing this display or invoking other displays simultaneously. Consequently, the displayed digital asset covers all other desktop icons and windows, effectively blocking the user from launching or resuming execution of any application program represented by those icons and windows.

To prevent remote attempts to capture the displayed digital asset, the viewer module 1406 obtains a status of processes being run on the receiving system and monitors the receiving system for any new processes or changes in existing processes while displaying the digital asset 1420. If the viewer module 1406 detects a change in processes at the receiving system, the viewer module may immediately terminate output of the digital asset 1420. Termination can occur without regard to the character of the new process (i.e., the new process may or may not be trying to capture the digital asset 1420). Thus, processes that might produce a window that covers the displayed digital asset 1420, such as, for example, a network disconnect digital asset, may cause the display to terminate, rather than to become a sub-level window.

In other implementations, the viewer module 1406 uses the character of the new process or change in process to determine whether to terminate output of the digital asset 1420. For example, the viewer module 1406 can look for a launch of a new process at the receiving system or an attempt by a process to take the foreground, that is, to become active for receipt of local input from either the mouse or the keyboard. Detecting such processes can cause output of the digital asset 1420 to terminate. Alternatively, the viewer module can allow output of the digital asset 1420 to continue when other generally trusted processes or process changes occur, such as receipt and notification of a new digital asset.

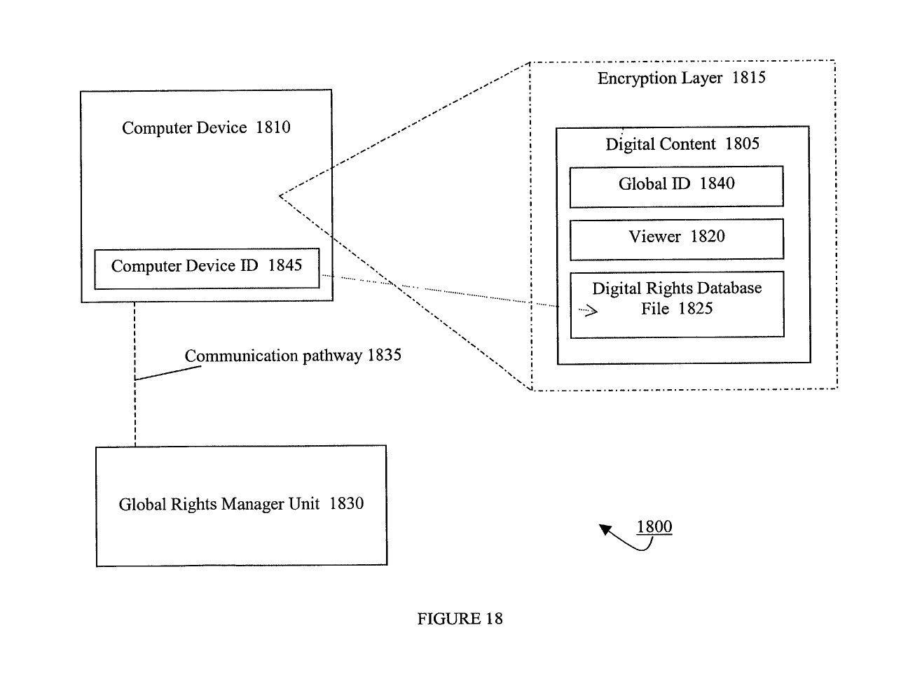

In another implementation, as shown in FIG. 18, controlling and managing digital assets may include a file protection system 1800 for protecting digital content 1805. This particular file protection system 1800 may protect and manage digital rights of digital content 1805 without the need to install software on the computer device 1810 of the recipient. For example, the digital content 1805 may be “wrapped” in an encryption layer 1815 that prevents manipulation of the digital content 1805 unless authorization is granted. The digital content 1805 may include a viewer 1820 for manipulating the digital content once authorization to manipulate the digital content 1805 is determined. The viewer 1820 may be particular to the type of digital content 1805 being controlled, or it may be capable of manipulating several types of digital content 1805 (e.g., video, audio, and text). The viewer 1820 may perform, for example, the authorization, identification, digital rights modification and decryption procedures as necessary. Furthermore, the digital content 1805 may include a digital rights database file 1825 that defines the extent to which the digital content 1805 may be manipulated. The digital rights database file 1825 may be encrypted along with the digital content 1805. All the elements (e.g., software) needed to control and manage the digital content 1805, along with the encryption layer 1815, may be bundled (“wrapped”) together as the encrypted digital content 1805 (i.e., a complete protected and operational package).

Moreover, the software needed to control and manage the digital content 1805 may include code that enables the digital content 1805 to be manipulated on multiple platforms, such as, for example, Macintosh® and Windows® platforms.

Authorization to manipulate the digital content 1805 may be granted in various ways, including, for example, accessing a global rights manager unit 1830 through a communication pathway 1835, or simply identifying the computer device 1810 (or end-user) on which the digital content 1805 is attempted to be manipulated and verifying that the digital content 1805 is authorized to be manipulated on the computer device 1810 (or end-user). Credential information (e.g., information about LAN, Windows NT domain, Windows NT group, or Windows NT user credentials) may be used to identify and authenticate the computer device 1810 (and end-user). Identifying the computer device 1810 may include comparing the credential information (stored, for example, in the encrypted digital rights database file 1825) with the specifics of the computer device 1810. Additionally, the viewer 1820 may interface with the end-user to authenticate the end-user to manipulate the digital content 1805. Moreover, the viewer 1820 may perform all the procedures necessary to ready the digital content 1805 for manipulation, including, for example, decryption of the digital content 1805. As such, the file protection system 1800 can be implemented as a standalone system, performing all procedures necessary to ready the digital content 1805 for manipulation at the computer device 1810.

In another implementation, the file protection system 1800 can be designed to function as a LAN-based system, which can provide a file protection system for an individual corporation. For example, the file protection system 1800 can be designed for a Windows® NT primary domain controller (PDC). This implementation will provide security against infiltration (e.g., hackers) and employee theft of digital content 1805 hosted by the corporate LAN. Authorized end-users can manipulate the digital content 1805 only by using specified viewers 1820 (which may reside on the LAN or as part of the encrypted digital content 1805). Furthermore, the digital content 1805 will remain encrypted in the encryption layer 1815 if forwarded/taken outside the corporate LAN, thereby preventing manipulation of the digital content 1805. In other words, the digital rights to manipulate the digital content 1805 may allow the digital content 1805 to be manipulated on only the machines authenticated as being part of the corporate LAN.

Alternatively the file protection system 1800 can be implemented as a centrally-managed digital rights management system, in which, for example, the viewer 1820 is required to access the global rights manager unit 1830 via a communication pathway 1835 to authenticate the digital content 1805 and authorize manipulation. Moreover, the communication pathway 1835 need not be a secure communications channel, since the encrypted digital content 1805 is transmitted as a complete file protection package.

Each copy of the digital content 1805 may be uniquely identified by a global ID 1840 embedded in the encrypted portion of the digital content 1805. Furthermore, each computer device 1810 is uniquely identifiable using a computer device ID 1845 generated, for example, by any one of various techniques of distinguishing one computer device 1810 from another. For example, the microprocessor electronic serial number can be ascertained, stored and used as the computer device ID 1845. Furthermore, the computer device ID 1845 may be recorded in the digital rights database file 1825 and transferred with the particular copy of the digital content 1805 so that future attempts to manipulate the digital content on the particular computer device 1810 identified by the computer device ID 1845 can be recognized and controlled by the viewer 1820. Also, the digital rights may be defined to allow manipulation on an end-user, machine, group, and/or network basis.

The viewer 1820 may include a GUI to allow the end-user to control the manipulation of the digital content 1805. For example, the GUI for video-based digital content 1805 may include graphical buttons for play, stop, fast-forward and reverse functions for controlling the video being displayed by the viewer 1820. Additionally, the GUI of the viewer 1820 may include a graphical “Upgrade” (or “Update”) button, which may allow the end-user to automatically contact the content provider (e.g., the global rights manager unit 1830) through the communication pathway 1835 to receive additional digital rights to manipulate the digital content 1805. Selecting the “Upgrade” button may invoke an upgrade procedure by which the end-user is requested to provide authentication information such as, for example, a password. Furthermore, the upgrade procedure may require the end-user to pay for additional rights to manipulate the digital content 1805. In this manner, the end-user can, for example, extend the time limits (or number of times) during which the digital content may be manipulated.

Regarding the control and management of the digital content 1805, the file protection system 1800 can control, for example, the number of times the digital content 1805 can be manipulated (e.g., installed, run, modified, viewed, heard, printed, copied, forwarded), whether one or more legitimate backup copies of the digital content can be made, which users or machines can manipulate the digital content 1805, whether an attempt to re-manipulate the digital content 1805 is allowed after a computer failure, whether copies or printouts are authorized and whether any duration or time usage limits will be imposed, and the duration of such limits. Moreover, the digital rights may include controlling the ability of digital content 1805 forwarded to another end-user or computer device to be manipulated, even if, for example, the digital rights to manipulate the digital content 1805 on the forwarding computer have expired. Additionally, the digital rights may include controlling viewing options (e.g., full screen or window-sized) of the digital content 1805, printing options, modification of the digital content 1805, and the duration of manipulation capabilities (e.g., available after or until a certain date, or for a certain period of time).

This file protection system 1800 allows carefully controlled and managed distribution of digital content 1805. For example, a content provider may distribute copies of the digital content 1805 that can be viewed only once on any given computer device 1810. Then, once the digital content 1805 is viewed on a particular computer device 1810, the viewer 1820 may prevent further decryption and subsequent manipulation of the digital content 1805 based on the information in the computer device ID 1845, and the global ID 1840 and digital rights database file 1825 of the digital content 1805. The file protection system 1800 can further prevent unauthorized forwarding of the digital content 1805, as the digital rights database file 1825 can specify on which particular computer devices 1810 the digital content 1805 may be manipulated. Specifically, the viewer 1820 may allow manipulation of the particular digital content 1805 on only the computer device 1810 having a particular computer device ID 1845. Alternatively, the file protection system 1800 can allow unlimited forwarding, with digital rights being restored with respect to each additional computer device 1810 on which the digital content 1805 is attempted to be manipulated. Additionally, the digital content 1805 being viewed with the viewer 1820 (e.g., in a partial window on a computer screen) may be prevented from being copied and pasted to another application. Also, screen shots of the displayed digital content 1805 may be prevented. These particulars may be determined by the content provider at the time the digital content 1805 is “wrapped” in the file protection system 1800, prior to being distributed.

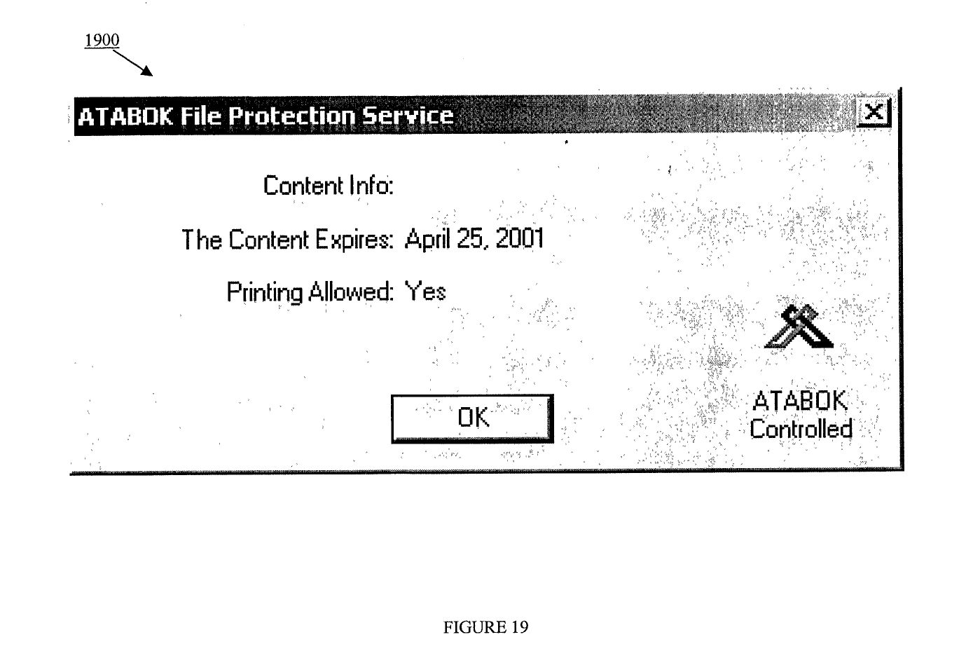

The selected restrictions and digital rights can be displayed in a dialog box 1900, as shown in FIG. 19, if a recipient wishes to view the digital rights, if the digital rights have expired, and/or if the unauthorized manipulation of the digital content 1805 is attempted.

The computer device ID, and the global ID 1840 and digital rights database file 1825 of the digital content 1805 may provide a means by which individual copies of the digital content 1805 may be identified and tracked by the original content provider. For example, the viewer 1820 may be required to contact the global rights manager unit 1830 to authenticate the digital content 1805 and to authorize manipulation on the computer device 1810 currently hosting the unique copy of the digital content 1805. At the same time, the global rights manager unit 1830 may collect tracking/usage information stored, for example, in the digital rights database file 1825 that pertains to the types of manipulations performed on the digital content 1805, distribution threads (i.e., historical chain of locations where the digital content 1805 has been hosted), and general digital rights history. Tracking the digital content 1805 allows the file protection system 1800 to completely control and manage the digital rights for the lifetime of the digital content 1805.

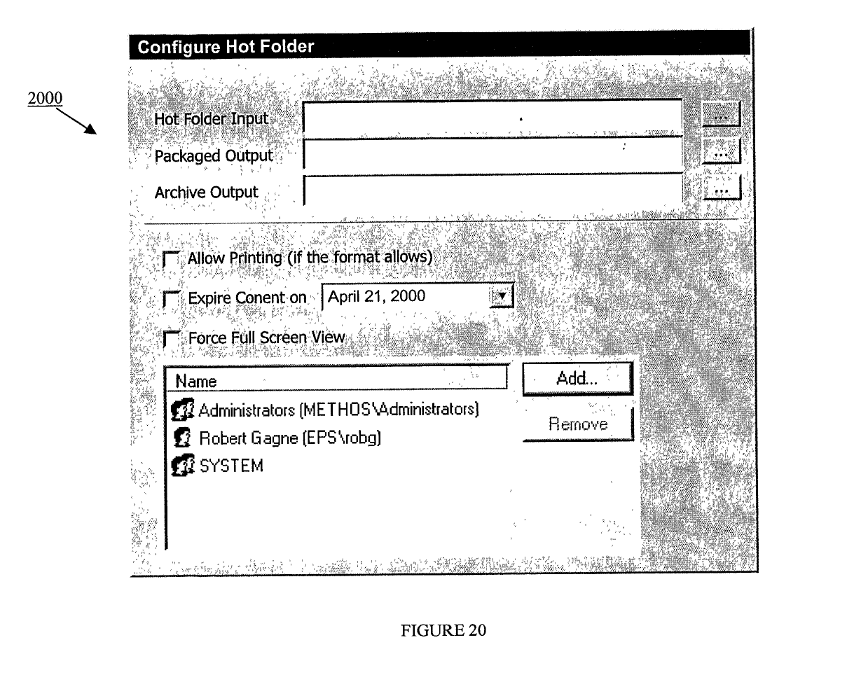

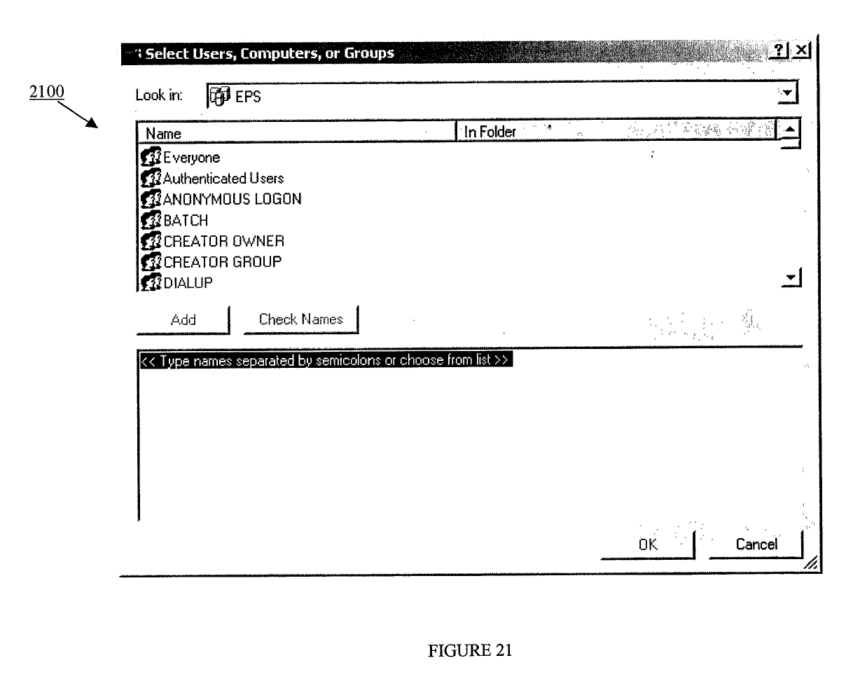

The file protection system 1800 allows a content provider the opportunity to select the options and levels of control over the digital content 1805 before and after distribution of the digital content 1805. Regarding “wrapping” the digital content 1805 into the file protection system 1800, a wrapping popup window (or GUI) 2000, as shown in FIG. 20, may be provided to assist the content provider with selecting the particular control and management features to be associated with a particular type or copy of the digital content 1805. Additional popup windows, such as a recipient chooser window 2100, shown in FIG. 21, may be provided. The wrapping popup window 2000 may be implemented as a simple posting mechanism, which can be fully automated or which can allow detailed interfacing with the content provider. For example, the content provider may simply drag-and-drop an icon of the unencrypted digital content 1805 into the wrapping popup window 2000, indicate a recipient, and send the “wrapped” digital content 1805 to the recipient. In the background, the file protection system 1800 may cause the digital content 1805 to be encrypted, associate the digital rights database file 1825, viewer 1820, and global ID 1840 with the digital content 1805, and record the global ID 1840 in the global rights manager unit 1830.

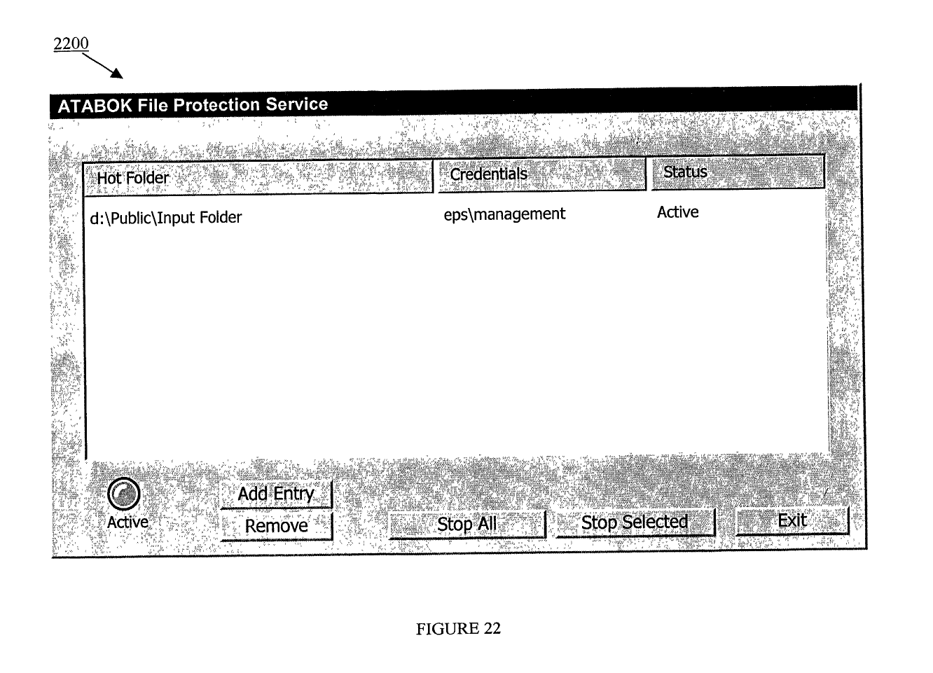

Alternatively, the “wrapping” of the digital content 1805 can be accomplished by way of a “hot folder” 2200 (a folder that is easily accessible), as shown in FIG. 22. In this implementation, for example, the content provider may simply drag-and-drop a digital content file into the window of the hot folder 2200, where the digital content 1805 will be wrapped and become accessible to, for example, authorized network users of a LAN on which the hot folder is hosted.

A more detailed wrapping popup window may have a number of options, for example, in a toolbar included in the GUI. The toolbar may include graphical buttons for, among other things, sending the wrapped digital content 1805 to a recipient or recipients, recalling the particular copy or type of digital content 1805 after it has been sent, a “chain letter” option that allows recipients to manipulate the digital content 1805 and forward it to another recipient, a “prevent chain letter” option that prevents the digital content 1805 from being manipulated on any computer device 1810 other than the particular computer device 1810 identified by the particular computer device ID 1845, and a “no copy” function which prevents copies of the digital content 1805 from being made (further, it may prevent copies of the wrapped digital content 1805 from being made). Moreover, the wrapping popup window may allow digital content 1805 of any size (e.g., large size movie files) to be wrapped and distributed to recipients.

Other implementations are within the scope of the following claims. For example, the systems and techniques described above may be implemented as one or more computer-readable software programs embodied on or in one or more articles of manufacture. The article of manufacture can be, for example, any one or combination of a floppy disk, a hard disk, hard-disk drive, a CD-ROM, a DVD-ROM, a flash memory card, an EEPROM, an EPROM, a PROM, a RAM, a ROM, or a magnetic tape. In general, any standard or proprietary, programming or interpretive language can be used to produce the computer-readable software programs. Examples of such languages include C, C++, Pascal, JAVA, BASIC, Visual Basic, LISP, PERL, and PROLOG. The software programs may be stored on or in one or more articles of manufacture as source code, object code, interpretive code, or executable code.

What is claimed is:

1. A method for controlling and managing a digital asset transmitted from a sending computer to a receiving computer, the method comprising:
establishing a first secure communication pathway between the sending computer and an intermediate server;
transmitting the digital asset from the sending computer to the intermediate server using the first secure communication pathway;
establishing a second secure communication pathway between the receiving computer and the intermediate server;
transmitting the digital asset from the intermediate server to the receiving computer using the second secure communication pathway;
transmitting to the receiving computer rights defining how the digital asset may be manipulated; and
storing the digital asset at the receiving computer in a way that permits manipulation of the digital asset only in ways that are consistent with the transmitted rights.

2. The method of claim 1 wherein storing the digital asset at the receiving computer in a way that permits manipulation of the digital asset only in ways that are consistent with the transmitted rights comprises storing the digital asset in a way that only permits the digital asset to be manipulated using an associated viewer.

3. The method of claim 1 wherein the rights defining how the digital asset may be manipulated are defined in a rights document that is transmitted to the receiving computer.

4. The method of claim 3 wherein the rights document comprises an XML document.

5. The method of claim 3 wherein the rights document includes information identifying a viewer to be used in accessing the digital asset.

6. The method of claim 3 wherein the rights document includes information about a party who originated the digital asset.

7. The method of claim 3 wherein the rights document includes information about the authority of the sending computer to transmit the digital asset.

8. The method of claim 3 wherein the rights document includes information about how to purchase rights to use the digital asset.

9. The method of claim 3 wherein the rights document includes information about how to purchase the digital asset.

10. The method of claim 3 wherein the rights document includes information about who is authorized to modify the rights defined in the rights document.

11. The method of claim 10 wherein the rights document includes a description of aspects of use of the digital asset to be tracked, the method further comprising tracking the aspects of use of the digital asset described in the rights document.

12. The method of claim 3 wherein the rights document is transferred to the receiving computer using the second secure communication pathway.

13. The method of claim 1 further comprising loading the rights into a secure database at the receiving computer.

14. The method of claim 13 wherein:
storing the digital asset at the receiving computer in a way that permits only controlled access to the digital asset comprises storing the digital asset in a way that only permits the digital asset to be manipulated using an associated viewer; and
the associated viewer interacts with the secure database when accessing the digital asset to ensure that the digital asset is manipulated consistently with the rights granted for manipulating the digital asset.

15. The method of claim 1 wherein the rights transmitted to the receiving computer control the ability of a user of the receiving computer to copy, view, print, execute, and modify the digital asset.

16. The method of claim 1 further comprising modifying the rights defining how the digital asset may be manipulated.

17. The method of claim 16 wherein modifying the rights defining how the digital asset may be manipulated comprises transmitting to the receiving computer a replacement set of rights defining how the digital asset may be manipulated.

18. The method of claim 16 wherein modifying the rights defining how the digital asset may be manipulated comprises transmitting to the receiving computer only changes to the rights defining how the digital asset may be manipulated.

19. The method of claim 16 further comprising transmitting to the sending computer a notification that the rights have been modified.

20. The method of claim 16 wherein:
storing the digital asset at the receiving computer in a way that permits manipulation of the digital asset only in ways that are consistent with the transmitted rights comprises storing the digital asset in a way that only permits the digital asset to be manipulated using an associated viewer,
the transmitted rights include information identifying a viewer to be used in manipulating the digital asset, and
modifying the rights defining how the digital asset may be manipulated comprises modifying the information identifying the viewer to be used in manipulating the digital asset to change the viewer to be used in manipulating the digital asset.

21. The method of claim 16 further comprising implementing an asset recall function by modifying the rights defining how the digital asset may be manipulated to prevent a user of the receiving computer from manipulating the digital asset in any way.

22. The method of claim 21 wherein implementing the asset recall function further comprises deleting the digital asset from the receiving computer.

23. The method of claim 1 further comprising maintaining a digital asset database at the intermediate server, the digital asset database including information identifying the digital asset and the rights transmitted to the receiving computer.

24. The method of claim 23 further comprising:
providing feedback from the receiving computer to the intermediate server about use of the digital asset; and
updating the digital asset database in response to the feedback.

25. The method of claim 24 wherein the rights defining how the digital asset may be manipulated indicate how feedback to the intermediate server is to be provided.

26. The method of claim 25 wherein the rights permit manipulation of the digital asset only when there is a live connection with the intermediate server.

27. The method of claim 25 wherein the rights permit manipulation of the digital asset only when the time since the last connection with the intermediate server is less than a predetermined value.

28. The method of claim 24 further comprising permitting the sending computer to access information in the digital asset database about the receiving computer's use of the digital asset.

29. The method of claim 28 wherein the sending computer uses the information in the digital asset database about the receiving computer's use of the digital asset in determining when to offer a modification of the digital asset.

30. The method of claim 28 wherein the sending computer uses the information in the digital asset database about the receiving computer's use of the digital asset in collecting demographic information about use and pricing of the digital asset.

31. The method of claim 24 wherein the receiving computer initiates feedback to the intermediate server in response to a particular manipulation of the digital asset.

32. The method of claim 31 wherein the particular manipulation that initiates feedback is identified by the rights defining how the digital asset may be manipulated.

33. The method of claim 24 wherein providing feedback from the receiving computer to the intermediate server about use of the digital asset comprises tracking consumption of the digital rights.

34. The method of claim 24 wherein providing feedback from the receiving computer to the intermediate server about use of the digital asset comprises tracking individual manipulations of the digital asset.

35. The method of claim 24 wherein providing feedback from the receiving computer to the intermediate server about use of the digital asset comprises tracking characteristics of individual portions of the digital asset.

36. The method of claim 1 wherein storing the digital asset at the receiving computer in a way that permits manipulation of the digital asset only in ways that are consistent with the transmitted rights comprises storing the digital asset in an encrypted format.

37. The method of claim 36 further comprising manipulating the digital asset, the manipulating comprising decrypting the digital asset.

38. The method of claim 37 wherein decrypting the digital asset comprises retrieving a key from the intermediate server and using the key in decrypting the digital asset.

39. The method of claim 37 wherein decrypting the digital asset comprises retrieving a key from the receiving computer and using the key in decrypting the digital asset.

40. The method of claim 1 wherein transmitting rights to the receiving computer comprises transmitting the rights before transmitting the digital asset.

41. The method of claim 1 wherein transmitting rights to the receiving computer comprises transmitting the rights after transmitting the digital asset.

42. The method of claim 1 wherein establishing the first secure communication pathway between the sending computer and the intermediate server comprises using public key encryption to generate a session key that then is used to encrypt communications between the sending computer and the intermediate server.

43. The method of claim 1 wherein establishing the second secure communication pathway between the receiving computer and the intermediate server comprises using public key encryption to generate a second session key that then is used to encrypt communications between the receiving computer and the intermediate server.

44. The method of claim 1 wherein:
establishing the first secure communication pathway comprises using an encryption technique appropriate for a physical location of the sending computer; and
establishing the second secure communication pathway comprises using an encryption technique appropriate for a physical location of the receiving computer.

45. A method for controlling and managing a digital asset installed on a computer, the method comprising:
installing on the computer rights defining how the digital asset may be manipulated, the installing comprising loading the rights into a secure database at the computer; and
storing the digital asset in a way that permits manipulation of the digital asset only in ways that are consistent with the installed rights.

46. The method of claim 45 wherein storing the digital asset in a way that permits only controlled access to the digital asset comprises storing the digital asset in a way that only permits the digital asset to be manipulated using an associated viewer.

47. The method of claim 45 wherein:
storing the digital asset at the receiving computer in a way that permits only controlled access to the digital asset comprises storing the digital asset in a way that only permits the digital asset to be manipulated using an associated viewer; and
the associated viewer interacts with the secure database when accessing the digital asset to ensure that the digital asset is manipulated consistently with the rights granted for manipulating the digital asset.

48. The method of claim 45 further comprising modifying the rights defining how the digital asset may be manipulated.

49. The method of claim 48 wherein modifying the rights defining how the digital asset may be manipulated comprises transmitting to the computer a replacement set of rights defining how the digital asset may be manipulated.

50. The method of claim 48 wherein modifying the rights defining how the digital asset may be manipulated comprises transmitting to the computer only changes to the rights defining how the digital asset may be manipulated.

51. The method of claim 48 further comprising maintaining a digital asset database at a remote server, the digital asset database including information identifying the digital asset and the rights installed at the computer.

52. The method of claim 51 further comprising:
providing feedback from the computer to the remote server about use of the digital asset; and
updating the digital asset database in response to the feedback.

53. The method of claim 52 wherein the rights defining how the digital asset may be manipulated indicate how feedback to the remote server is to be provided.

54. The method of claim 53 wherein the rights permit manipulation of the digital asset only when there is a live connection with the remote server.

55. The method of claim 53 wherein the rights permit manipulation of the digital asset only when the time since the last connection with the remote server is less than a predetermined value.

56. The method of claim 51 wherein the receiving computer initiates feedback to the remote server in response to a particular manipulation of the digital asset.

57. The method of claim 56 wherein the particular manipulation that initiates feedback is identified by the rights defining how the digital asset may be manipulated.

58. The method of claim 51 wherein providing feedback from the computer to the remote server about use of the digital asset comprises tracking consumption of the digital rights.

59. The method of claim 51 wherein providing feedback from the computer to the remote server about use of the digital asset comprises tracking individual manipulations of the digital asset.

60. A method for controlling and managing a digital asset transmitted from a sender to multiple recipients, the method comprising:
transmitting the digital asset from the sender to the recipients;
transmitting to the recipients rights defining how the digital asset may be manipulated;
storing the digital asset in storage locations associated with the recipients in a way that permits manipulation of the digital asset only in ways that are consistent with the transmitted rights; and
permitting certain ones of the recipients to modify the rights defining how the certain ones of the recipients may manipulate the digital asset.

61. The method of claim 60 wherein the transmitted rights permit each recipient to manipulate the digital asset in the same way.

62. The method of claim 60 wherein the transmitted rights indicate which recipients may modify the rights.

63. The method of claim 62 wherein the transmitted rights indicate one or more classes of recipients that may modify the rights.

64. The method of claim 60 further comprising permitting the certain ones of the recipients to transmit the digital asset to other recipients and to control the rights transmitted to the other recipients.

65. A method for controlling and managing a digital asset transmitted from a sender to a recipient, the method comprising:
transmitting the digital asset from the sender to the recipient;
transmitting to the recipient a first set of rights defining how the digital asset may be manipulated;
storing the digital asset in a storage location associated with the recipient in a way that permits manipulation of the digital asset only in ways that are consistent with the transmitted rights; and
permitting the recipient to transmit the digital asset to another recipient along with a second set of rights defining how the digital asset may be manipulated by the other recipient.

66. The method of claim 65 wherein the second set of rights is more restrictive than the first set of rights.

67. A system for dynamically managing digital rights of digital content, comprising:
a digital content package comprising digital content data and a digital rights manager wherein the digital content data includes encrypted data; and
a digital rights database operable to store digital rights relating to the digital content data,
wherein the digital rights manager includes code that is operable to:
determine whether digital rights to manipulate the digital content data exist in the digital rights database; and
decrypt the encrypted data of the digital content data to generate decrypted digital content that can be manipulated.

68. The system of claim 67 further comprising:
a computer device operable to manipulate the decrypted digital content; and
a global rights unit operable to manage the digital rights database and communicate with the computer device wherein the global rights unit is located remote from the computer device.

69. The system of claim 68 wherein the global rights unit includes a global clock wherein the computer device includes a local clock, and wherein the global rights unit is operable to synchronize the local clock with the global clock when a communication link between the computer device and the global rights unit is available.

70. The system of claim 67 wherein the digital rights manager is operable to decrypt the encrypted data of the digital content only if the digital rights to manipulate the digital content data exist in the digital rights database.

71. The system of claim 67 further comprising a computer device wherein the decrypted digital content includes an executable file that is operable to run on the computer device.

72. The system of claim 67 wherein the digital content package further comprises a viewer module including viewer code operable to facilitate manipulation of the decrypted content.

73. The system of claim 72 further comprising a computer device wherein the viewer code is operable to allow an end-user to manipulate the decrypted digital content on the computer device.

74. The system of claim 68 wherein the digital rights database comprises:
a local digital rights database file stored at a computer device comprising individual digital rights information related to an individual digital content package; and
a global digital rights database located at the global rights unit comprising digital rights information related to a plurality of digital content packages.

75. The system of claim 74 wherein the local digital rights database and the global digital rights database are operable to be harmonized with each other using a communication pathway.

76. The system of claim 74 wherein the local digital rights database is operable to modify data in the global digital rights database using a communication pathway connecting the local digital rights database with the global digital rights database.

77. The system of claim 74 wherein the global digital rights database is operable to modify data in the local digital rights database using a communication pathway connecting the local digital rights database with the global digital rights database.

78. The system of claim 67 wherein the digital rights to manipulate the digital content data are automatically modified each time the digital content data is manipulated.

79. The system of claim 67 wherein the digital rights to manipulate the digital content data are automatically modified according to time-based criteria.

80. The system of claim 68 further comprising a tracking manager module operable to gather tracking information concerning the digital content data from the digital rights database.

81. The system of claim 80 wherein the tracking manager module is further operable to manipulate the tracking information concerning the digital content data.

82. The system of claim 80 wherein each of a plurality of copies of the digital content data comprises a unique identifier operable to distinguish the plurality of copies of the digital content data from each other, and wherein the tracking information concerning the digital content data includes routing information of individual copies of the digital content data, identities of computer devices at which the individual copies of the digital content data reside, and the number of copies of the digital content data in existence.

83. A method of providing secure collaboration among several collaborators, the method comprising:
providing a digital asset to a collaborator in an encrypted format;
permitting the collaborator to edit the digital asset using an authorized viewer program; and
saving changes made by the collaborator in an encrypted format by creating a collaboration file by encrypting a change document representing the changes made by the collaborator and the original encrypted digital asset.

84. The method of claim 83 further comprising:
providing the collaboration file to another collaborator;
permitting the other collaborator to edit the digital asset using an authorized viewer program and the collaboration file; and
saving changes made by the other collaborator in an encrypted format by creating a second collaboration file by encrypting a second change document representing the changes made by the other collaborator and the collaboration file such that a second encryption layer is added by the other collaborator.

85. The method of claim 84 further comprising presenting to the other collaborator the digital asset and the changes made by the first collaborator in a way that distinguishes the original digital asset from the changes made by the first collaborator.

86. The method of claim 85 wherein the digital asset is presented using a font different from a font used to present the changes made by the first collaborator.

87. The method of claim 85 wherein the digital asset is presented using a color different from a color used to present the changes made by the first collaborator.

88. The method of claim 84 further comprising giving different collaborators different rights with respect to editing the digital asset.

89. The method of claim 84 further comprising giving different collaborators different rights with respect to viewing changes made by other collaborators.

90. The method of claim 83 further comprising feeding the changes of the change document to an entity that provided the digital asset to the collaborator.
